(19) United States
(12) Patent Application Publication
(10) Pub. No.: US 2025/0190263 A1
(43) Pub. Date: Jun. 12, 2025

(54) SYSTEMS AND METHODS FOR MANAGING RESOURCE REQUESTS TO PERFORM TRANSACTIONS

(71) Applicant: Synchrony Bank, Stamford, CT (US)

(72) Inventors: Syedagul Naqvi, Stamford, CT (US); Madhu Sirigiri, Stamford, CT (US); Ashok Uppalapati, Stamford, CT (US); Vamshi Veggalam, Stamford, CT (US)

(21) Appl. No.: 18/975,193

(22) Filed: Dec. 10, 2024

Related U.S. Application Data
(60) Provisional application No. 63/609,176, filed on Dec. 12, 2023.

(51) Int. Cl. G06F 9/50; G06F 9/46; H04L 9/32

(52) U.S. Cl. CPC G06F 9/5033; G06F 9/466; H04L 9/3247

(57) ABSTRACT

Systems and methods provide an application-programming interface (API) framework for fulfilling transactions based on resources provided by a resource provider. A computer-implemented method can include receiving user-profile data associated with a request for resources to fulfill a transaction. The computer-implemented method can also include constructing an API request based on the user-profile data. When the API request is received, the resource server can dynamically generate and transmit a response message. The computer-implemented method can also include parsing the response message to identify a set of installment options. When a particular installment option is selected, the resource server can authorize transmittal of one or more resources associated with the selected installment option. The computer-implemented method can also include fulfilling the transaction after transmitting the selected installment option. The computer-implemented method can also include receiving the one or more resources associated with the selected installment option after fulfillment of the transaction.

### CROSS-REFERENCES TO RELATED APPLICATIONS

The present application claims priority from and is a non-provisional of U.S. Provisional Application No. 63/609,176, entitled “SYSTEMS AND METHODS FOR MANAGING RESOURCE REQUESTS TO PERFORM TRANSACTIONS” filed Dec. 12, 2023, the contents of which are herein incorporated by reference in its entirety for all purposes

### FIELD

The present disclosure relates generally to a web-server framework for fulfilling transactions based on resources provided by a resource server. In one example, the systems and methods described herein may be used to an application programming interface for fulfilling transactions based on resources provided by a resource server.

### SUMMARY

Disclosed embodiments may provide an application-programming interface (API) framework for fulfilling transactions based on resources provided by a resource provider. A computer-implemented method can include receiving user-profile data associated with a request for resources to fulfill a transaction. The computer-implemented method can also include constructing an API request based on the user-profile data. The computer-implemented method can also include transmitting the API request. In some instances, transmitting the API request includes generating a digital signature for the API request, encrypting the API request to generate an encrypted request, and transmitting the digital signature and the encrypted request. When the API request is received at a resource server, the resource server can dynamically generate and transmit a response message. In some instances, the response message is generated based on a score generated by a data-aggregation server.

The computer-implemented method can also include parsing the response message to identify a set of installment options. In some instances, the set of installment options includes an option for a user to submit a portion of the requested resources to the resource server before receiving the requested resources. The set of installment options can also include an option to immediately acquire the requested resources. The set of installment options can also include a denial of providing the requested resources but instead an approval associated with a portion of the requested resources.

The computer-implemented method can also include associating the set of installment options with a set of graphical user-interface elements. The computer-implemented method can also include receiving a selection of an installment option. In some instances, the selection of the installment option is associated with a user interaction with a graphical user-interface element.

The computer-implemented method can also include transmitting the selected installment option. When the selected installment option is received at the resource server, the resource server can authorize transmittal of one or more resources associated with the selected installment option. The computer-implemented method can also include fulfilling the transaction after transmitting the selected installment option. The computer-implemented method can also include receiving the one or more resources associated with the selected installment option after fulfillment of the transaction. In some instances, the computer-implemented method includes accessing terms-and-conditions data associated with the selected installment option before transmitting the selected installment option and transmitting the terms-and-conditions data. When a user device receives the terms-and-conditions data, the user device can transmit an acceptance of the terms-and-conditions data.

In some instances, constructing the API request includes generating error messages in response to the API request. For example, the computer-implemented method can also include parsing the user-profile data to determine that the user-profile data include one or more erroneous data components and generating an error message to be presented on a web page. Additionally or alternatively, the computer-implemented method can also include receiving a request to terminate the transaction and transmitting the one or more resources associated with the selected installment option when the request to terminate the transaction is received.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram for fulfilling transactions based on resources provided by a resource provider, according to some embodiments.

FIG. 2 illustrates an example system architecture for fulfilling transactions based on resources provided by a resource provider, according to some embodiments.

FIG. 3 illustrates another example system architecture for fulfilling transactions based on resources provided by a resource provider, according to some embodiments.

FIG. 4 shows an illustrative example of a process for fulfilling transactions based on resources provided by a resource provider, in accordance with some embodiments.

FIG. 5 illustrates an example architecture of a neural network for processing user-profile data, according to some embodiments.

FIG. 6 illustrates an example schematic diagram that shows example API requests and responses, according to some embodiments.

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide an application-programming interface (API) framework for fulfilling transactions based on resources provided by a resource provider. In some embodiments, a web server receives a request from a user to fulfill a given transaction. The web server can be associated with a provider of goods or services (e.g., a cloud service provider, an e-commerce website). The web server can fulfill the transaction in exchange for being compensated with corresponding resources. As an illustrative example, the web server can be associated with an e-commerce website that sells home appliances including refrigerators, washing machines, stovetop cookers, and dishwashers.

In some instances, the user desires for the transaction to be immediately fulfilled, but may not have adequate resources to complete the transaction. Regarding the above situation, the user can submit a request for resources from a resource provider (e.g., a financial institution) to immediately fulfill the transaction, in exchange for the user reimbursing the resource provider across an extended time period. The request for resources can include an amount of resources for fulfilling the transaction and user-profile data of the user. The user-profile data can include personally-identifiable information (PII) of a user, including any information that can be used to distinguish or trace an individual's identity. For example, PII of the user can include name, address, age, social security number, credit score, date and place of birth, mother's maiden name, or biometric records associated with the user. The user-profile data can be analyzed by the resource server to determine how the resources should be reimbursed. For example, the resource server can dynamically determine various aspects of an installment plan based on the user-profile data, including an amount of resources authorized for distribution (which may be different from the amount of requested resources), a time period for reimbursing the requested resources, deposits needed to secure the requested resources, and the like.

The resources for fulfilling the transaction can include any tangible or intangible assets that can be used to obtain a particular item or service. For example, a user can request funds to purchase a washing machine listed on an e-commerce website. In another example, a user can request funds to obtain graphic-processing unit (GPU) instances for training and deploying a machine-learning algorithm implemented on an application server. In some instances, a particular type of resources used to immediately fulfill the transaction is different from the type of resources used for reimbursing the resource provider over the extended time period. For example, financial resources can be requested by the user to immediately deploy the machine-learning model, and the user can reimburse the use of such resources with cryptocurrency over the extended time period. Additionally or alternatively, an amount of resources used to immediately fulfill the transaction is different from the amount of resources used for reimbursing the resource provider over the extended time period. For example, the resource provider may add an additional amount (e.g., an interest) to the amount of resources to be reimbursed by the user.

The web server can dynamically construct an application-programming interface (API) request based on the user-profile data. The resource server can be configured to receive the request for resources forwarded by the web server, manage the request for resources in real-time based on the user-profile data, dynamically distribute the resources to the web server if the request is approved, and dynamically implement an installment plan for the user in real-time to reimburse the resources over the extended time period of time (e.g., 24 months).

In some instances, the web server dynamically constructs the API request in real-time by selecting one or more portions of the user-profile data (e.g., name, social security number) to construct the API request. In particular, the API requests can be constructed in real-time as the web server continues to receive additional user-profile data from various users. The non-static, real-time features of processing the user-profile data may result in having the API request that is different from other API requests that would be generated later in time (e.g., after 10 seconds, after 1 minute, after 5 minutes, after 30 minutes). In the event that the user-profile data include one or more erroneous data components, the web server may generate an error message to be presented on a web page. For example, the web server generates the error message in response to determining that the first name includes numerical characters. After receiving the error message, the user can resubmit the request for resources for fulling the transaction.

The web server can transmit the API request. The web server can transmit the API request to the resource server across a communication network, at which the resource server analyzes the API request. Prior to transmittal, the API request can be cryptographically protected from unauthorized access. The cryptographic protection ensures that the PII of the user-profile data is protected from unauthorized third-party access (e.g., packet sniffing). For example, the web server can generate a digital signature for the API request, encrypt the API request to generate an encrypted request, and transmit the digital signature and the encrypted request. In another example, the resource server can generate and transmit a digital certificate to the web server. The web server can utilize the digital certificate to digitally sign the API request. The web server can then transmit the digitally signed API request to the resource server, such that the resource server can authenticate the digitally signed API request.

In some instances, the user-profile data and any additional user data are accessed by the resource server based on an authentication token generated by the web server or other third-party systems. For example, after the user permits a third-party system (e.g., another financial institution, social-media platform) to share additional user data, the third-party system can issue the authentication token to the resource server. The resource server can use the authentication token to access the user-profile data and the additional user data from the third-party system. The additional user data accessed from the web server or the third-party system can allow the resource server to perform a more accurate assessment of the user's capability of reimbursing the requested resources over the extended time period of time. In some instances, the use of authentication tokens increases a likelihood that the resource server approves the installment options for the user.

When the API request is received at the resource server, the resource server can dynamically generate and transmit a response message. In some instances, the response message includes a set of installment options. The set of installment options can include different arrangements for the user to reimburse the requested resources to the resource server over an extended time period of time, in exchange for the resource server to immediately provide the resources to the web server to fulfill the transaction. For example, the set of installment options can include an option to provide an entirety of the requested resources to the web server. In some instances, the set of installment options includes an option for a user to submit a portion of the requested resources as a prerequisite to receiving the requested resources. Additionally or alternatively, the set of installment options can include a denial of providing the requested resources but instead an approval associated with a portion of the requested resources.

As describe above, the set of installment options can also include an interest rate associated with each installment option and a repayment plan that specifies a portion of resources to be submitted at every interval (e.g., weekly, monthly) until the entirety of the resources are reimbursed to the resource server after a predetermined time period. In some instances, the resource server determines the set of installment options in real-time, as the resource server continues to receive additional user-profile data associated with various users. The non-static, real-time features of receiving and processing the user-profile data may result in determining the set of installment options that are different from other installment options that would be determined later in time (e.g., after 10 seconds, after 1 minute, after 5 minutes, after 30 minutes) for the user.

To determine the set of installment options, the resource server can process in real-time the user-profile data in the API request and assess in real-time the capability of the corresponding user in reimbursing the requested resources over the extended time period of time. The resource server can assess the user's capability in real-time, as the resource server continues to receive additional API requests from the web server. The non-static, real-time features of processing the user-profile data by the resource server may result in having the assessment that are different from other assessments that would be determined later in time (e.g., after 10 seconds, after 1 minute, after 5 minutes, after 30 minutes). In some instances, if additional user data was accessed using authentication tokens, the resource server immediately approves the API request and provide the set of installment options. The use of the authentication tokens associated with the user increases the likelihood of the user being approved for the set of installment options.

For example, the assessment can include the resource server analyzing in real-time the user-profile data, determining in real-time the creditworthiness of the user, and generating in real-time a score that represents the capability of the corresponding user in reimbursing the requested resources. Additionally or alternatively, the assessment can include dynamically submitting a credit inquiry for the user. The resource server can submit the credit inquiry to a data-aggregation server (e.g., a credit-bureau agency), at which the data-aggregation server can analyze the financial metrics (e.g., a credit score) of the user and transmit a score that represents the capability of the corresponding user in reimbursing the requested resources.

After the resource server transmits the response message based on the API request, the web server can receive and parse the response message to identify the set of installment options. The web server can then dynamically associate the set of installment options from the response message with a set of graphical user-interface elements. The set of graphical user-interface elements can then be presented on a display of the webpage. For example, the webpage associated with the web server can display the following user-interface elements: (i) a first user-interface element corresponding to a first installment option associated with securing an entire amount of the requested resources; (ii) a second user-interface element corresponding to a second installment option associated with a request for a user to submit a portion of the requested resources as a prerequisite for receiving the requested resources; and (iii) a third user-interface element corresponding to a third installment option associated with receiving a portion of the requested resources.

The web server can receive a selection of an installment option from the user device. The selection of the installment option indicates that the user prefers the selected installment option over other installment options within the set. In some instances, the selection of the installment option is associated with a user interaction with a graphical user-interface element. The user interaction can include a user clicking a graphical user-interface element associated with a particular installment option. In some instances, the user interaction includes a user selecting the particular installment option from a drop-down menu associated with the set of installment options.

The web server can dynamically transmit the selected installment option. In some instances, the web server constructs in real-time a subsequent API request that includes a user identifier associated with the user, the selected installment option, and an authorization for the resource server to proceed with distributing the requested resources to the web server in accordance with the selected installment option. Similar to the initial API request, the web server can construct the subsequent API request in real-time as the web server continues to receive additional selection of installment options from various users. In some instances, if the selected installment option requires a portion of the resources to be submitted as a prerequisite for securing the resources, the subsequent API request can include the portion of the resources submitted by the user. When the selected installment option is received at the resource server, the resource server can dynamically transmit in real-time one or more resources associated with the selected installment option.

The web server can dynamically fulfill the transaction in real-time after transmitting the selected installment option. The web server can fulfill the transaction in real-time, as the web server continues to process other user-profile data, construct other API requests, process other installment options, and fulfill transactions from other users. Continuing with the above example, the e-commerce website can authorize in real-time the purchase of the washing machine after transmitting the selected installment option to the resource server. In another example, a cloud-service provider can provide in real-time the GPU instances after transmitting the selected installment option to the resource server, such that the GPU instances can be used for training and deploying the machine-learning algorithm. The fulfillment of the transaction can include performing one or more additional actions (e.g., shipping the washing machine) in real-time after performing the transaction itself.

The web server can receive the one or more resources associated with the selected installment option after fulfillment of the transaction. The web server can transmit a notification to the resource server indicating that the transaction has been fulfilled (e.g., authorize purchase of the washing machine). In some instances, the resource server dynamically provides the one or more resources associated with the selected installment option after the one or more additional actions performed by the web server. For example, the resource server can provide the one or more resources after the e-commerce website confirms that the washing machine has been delivered to the customer.

### I. Overview of Fulfilling Transactions Based on Resources Provided by a Resource Provider

### A. Example Implementation

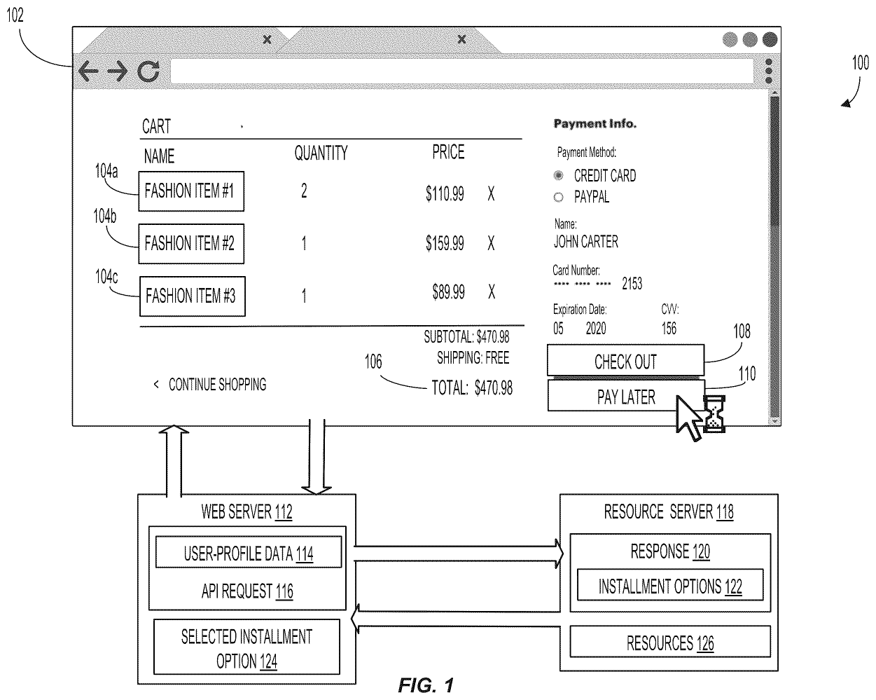

FIG. 1 illustrates an example schematic diagram 100 for fulfilling transactions based on resources provided by a resource provider, according to some embodiments. FIG. 1 illustrates a web browser 102 showing a display of various fashion items 104a-c intended to be purchased by a user. The total price 106 of purchasing fashion items 104a-c is also shown on the web browser 102. At this stage of the transaction, the user can be presented with various options to fulfill the transaction to purchase the fashion items 104a-c. For example, the web browser 102 can present a “Check Out” option 108 to purchase the fashion items 104a-c by providing a one-time payment of resources. The browser 102 can also present a “Pay Later” option 110, in which the user can request a resource provider (e.g., a financial institution) to immediately fulfill the transaction, thus allowing the user to avoid an immediate payment of resources. The request for resources allows the resource provider to immediately fulfill the transaction on behalf of the user, in exchange for the user reimbursing the resource provider over an extended time period.

As the user proceeds with selecting the “Pay Later” option 110, a web server 112 receives a request for the resource provider to immediately fulfill the transaction. The web server 112 can be associated with an e-commerce provider that sells various fashion items, including fashion items 104a-c. The request can include an amount of resources that can be used for fulfilling the transaction. In some instances, the request also includes user-profile data 114 of the user. The user-profile data 114 can include personally-identifiable information (PII) of a user, including any information that can be used to distinguish or trace an individual's identity. For example, PII of the user can include name, address, age, social security number, credit score, date and place of birth, mother's maiden name, or biometric records associated with the user. The user-profile data can be analyzed by the resource server to determine whether or how the resources should be reimbursed.

The resources for fulfilling the transaction can include any tangible or intangible assets that can be used to obtain a particular item or service. In some instances, a particular type of resources used to immediately fulfill the transaction is different from the type of resources used for reimbursing the resource provider over the extended time period. For example, a particular type of currency can be requested by the user to purchase the fashion items 104a-c, and the user can reimburse with monthly payments of a different type of currency. Additionally or alternatively, an amount of resources used to immediately fulfill the transaction is different from the amount of resources used for reimbursing the resource provider over the extended time period. For example, the resource provider may add interest to the provided amount of resources, at which the updated amount is reimbursed by the user over the extended time period.

The web server 112 can dynamically construct an API request 116 based on the user-profile data 114. APIs can include mechanisms that enable two different servers (e.g., the web server, a resource server) to communicate with each other using a set of definitions and protocols. The resource server can be associated with a resource provider (e.g., a financial-services institution) that provides the resources for fulfilling the transaction. The web server 112 can transmit the constructed API request 116 to a resource server 118. The resource server 118 can be associated with a resource provider (e.g., a financial-services institution) that provides the resources for fulfilling the transaction. The resource server 118 can be configured to receive the request for resources forwarded by the web server 112, manage the request for resources in real-time based on the user-profile data 114, distribute in real-time the resources to the web server if the request is approved, and implement in real-time an installment plan for the user to reimburse the resources over the extended time period of time (e.g., 24 months).

In some instances, the web server 112 selects one or more portions of the user-profile data 114 to dynamically construct the API request 116 in real-time. In particular, the API requests can be constructed in real-time as the web server 112 continues to receive additional user-profile data from various users. The non-static, real-time features of processing the user-profile data 114 may result in having the API request 116 that is different from other API requests that would be generated later in time (e.g., after 10 seconds, after 1 minute, after 5 minutes, after 30 minutes). For example, the one or more portions of the user-profile data 114 can include name, date of birth, and social security number of the user. The web server 112 can additionally parse the user-profile data 114 to determine presence of any errors. The errors can include data input that violate syntax rules associated with a corresponding data field of the user-profile data 114. For example, the “first name” data field can include a syntax rule that does not permit numerical characters. In the event that the “first name” data field includes any numerical characters, the web server 112 may generate an error message to be presented on the web browser 102. After receiving the error message, the user can resubmit the request for resources to continue with the transaction.

The web server 112 can transmit the constructed API request 116. The web server 112 can transmit the API request 116 to the resource server 118, which analyzes the API request 116 and generates a corresponding response message 120. Prior to transmittal, the web server 112 can digitally sign and encrypt the API request 116 to protect its corresponding data from unauthorized access. Cryptographic protection (e.g., encryption) can thus be used to enhance the security of communication between the web server 112 and the resource server 118. For example, the web server 112 can generate a digital signature for the API request 116, encrypt the API request 116 to generate an encrypted request, and transmit the digital signature and the encrypted request to the resource server 118. In another example, the resource server 118 can generate and transmit a digital certificate to the web server 112. The web server 112 can utilize the digital certificate to digitally sign the API request 116. The web server 112 can then transmit the digitally signed API request 116 to the resource server 118, such that the resource server 118 can authenticate the digitally signed API request 116.

In some instances, the user-profile data 114 and any additional user data are accessed by the resource server 118 based on an authentication token generated by the web server 112 or other third-party systems. For example, after the user permits a third-party system (e.g., another financial institution, social-media platform) to share additional user data, the third-party system can issue the authentication token to the resource server 118. The resource server 118 can use the authentication token to access the user-profile data 114 and the additional user data from the third-party system. The additional user data accessed from the web server 112 or the third-party system can allow the resource server 118 to perform a more accurate assessment of the user's capability of reimbursing the requested resources over the extended time period of time. In some instances, the use of authentication tokens increases a likelihood that the resource server 118 approves the installment options for the user.

When the API request 116 is received at the resource server 118, the resource server 118 can dynamically generate and transmit the response message 120. The response message 120 can be formatted into a particular data structure (e.g., JSON, XML) that can be parsed and interpreted by the web server 112. In some instances, the response message 120 includes a set of installment options 122. The set of installment options 122 can include different arrangements for reimbursing the requested resources over an extended time period of time, in exchange for the resource server 118 to immediately provide the resources to the web server 112 to fulfill the transaction. For example, the set of installment options 122 can include an option for the user to submit a portion of the requested resources as a prerequisite to receiving the requested resources. Additionally or alternatively, the set of installment options 122 can include a denial of providing the requested resources but instead an approval associated with a portion of the requested resources. As describe above, the set of installment options 122 can also include an interest rate associated with each installment option and a repayment plan that specifies a portion of resources to be submitted at every interval (e.g., weekly, monthly) until the entirety of the resources are reimbursed to the resource server after a predetermined time period. In some instances, the resource server 118 determines the set of installment options in real-time, as the resource server 118 continues to receive additional user-profile data associated with various users. The non-static, real-time features of receiving and processing the user-profile data may result in determining the set of installment options that are different from other installment options that would be determined later in time (e.g., after 10 seconds, after 1 minute, after 5 minutes, after 30 minutes) for the user.

To determine the set of installment options 122, the resource server 118 can process in real-time the user-profile data 114 in the API request 116 and assess in real-time the capability of the corresponding user in reimbursing the requested resources over the extended time period of time. The resource server 118 can assess the user's capability in real-time, as the resource server 118 continues to receive additional API requests from the web server. The non-static, real-time features of processing the user-profile data 117 by the resource server 118 may result in having the assessment that are different from other assessments that would be determined later in time (e.g., after 10 seconds, after 1 minute, after 5 minutes, after 30 minutes). In some instances, if additional user data was accessed using authentication tokens, the resource server 118 immediately approves the API request 116 and provide the set of installment options 122. The use of the authentication tokens associated with the user increases the likelihood of the user being approved for the set of installment options 122.

For example, the assessment can include the resource server 118 analyzing in real-time the user-profile data 114, determining in real-time the creditworthiness of the user, and generating in real-time a score that represents the capability of the corresponding user in reimbursing the requested resources. Additionally or alternatively, the assessment can include submitting a credit inquiry for the user. The resource server can submit the credit inquiry to a data-aggregation server (e.g., a credit-bureau agency), at which the data-aggregation server can analyze the financial metrics (e.g., a credit score) of the user and transmit a score that represents the capability of the corresponding user in reimbursing the requested resources.

The resource server 118 can transmit the response message 120 to the web server 112. The web server 112 can receive and parse the response message 120 to identify the set of installment options 122. The web server 112 can initially identify a status code from the response message 120 and determine whether the response message 120 includes the requested information based on the status code. For example, the web server 112 can first identify that the status code corresponds to a successful response “200”, at which the web server can proceed with parsing the response message 120. In another example, the web server 112 can identify that the status code corresponds to an unauthorized request “401”, at which the web server 112 can generate an error message on the web browser 102 instead of presenting the set of installment options 122 to the user. To parse the response message 120, the web server 112 can extract key-value pairs of the response message 120 that are associated with the set of installment options 122.

The web server 112 can then associate the set of installment options 122 from the response message with a set of graphical user-interface elements. The set of graphical user-interface elements can then be presented on a display of the web browser 102 (not shown). For example, the webpage associated with the web server can display the following user-interface elements: (i) a first user-interface element corresponding to a first installment option associated with securing an entire amount of the requested resources; (ii) a second user-interface element corresponding to a second installment option associated with a request for a user to submit a portion of the requested resources as a prerequisite for receiving the requested resources; and (iii) a third user-interface element corresponding to a third installment option associated with receiving a portion of the requested resources.

The web server 112 can receive a selection of an installment option 124 from the user device. The selection of the installment option 124 indicates that the user prefers the selected installment option over other installment options within the set. In some instances, the selection of the installment option 124 is associated with a user interaction with a graphical user-interface element. The user interaction can include a user clicking a graphical user-interface element displayed on the web browser 102, in which the graphical user-interface element is associated with a particular installment option. In some instances, the user interaction includes a user selecting the particular installment option from a drop-down menu displayed on the web browser 102.

The web server 112 can dynamically transmit the selected installment option 124. In some instances, the web server 112 constructs in real-time a subsequent API request that includes a user identifier associated with the user, the selected installment option 124, and an authorization for the resource server to proceed with distributing the requested resources to the web server in accordance with the selected installment option. Similar to the API request 116, the web server 112 can construct the subsequent API request in real-time as the web server continues to receive additional selection of installment options from various users. In some instances, if the selected installment option 124 requires a portion of the resources to be submitted as a prerequisite for securing the resources, the subsequent API request can include the portion of the resources submitted by the user. When the selected installment option 124 is received at the resource server 118, the resource server 118 can transmit in real-time one or more resources 126 associated with the selected installment option 124.

In some instances, before further processing the selected installment option 124, the web server 112 provides terms-and-conditions data associated with the selected installment option 124 to the user. The terms-and-conditions data can include information governing the contractual relationship between the resource provider and the user. In some instances, the resource server 118 provides the terms-and-conditions data associated with the selected installment option 124 to the web server 112, at which the web server 112 can provide the terms-and-conditions data to the user. The web server 112 can require the user to accept the terms-and-conditions data before transmitting the selected installment option 124 to the resource server 118. The user can then determine whether to accept the information set forth in the terms-and-conditions data. If the user rejects the terms-and-conditions data, the web server 112 can transmit a notification to the resource server 118 that the request for resources has been canceled. If the user accepts the terms-and-conditions data, the web server 112 can proceed with transmitting a user-approval of the selected installment option 124.

The web server 112 can dynamically fulfill the transaction after transmitting the selected installment option. The web server 112 can fulfill the transaction in real-time, as the web server continues to process other user-profile data, construct other API requests, process other installment options, and fulfill transactions from other users. For example, the web server can authorize in real-time the purchase of the fashion items 104a-c after transmitting the selected installment option 124 to the resource server 118. In some instances, to fulfill the transaction, the web server 112 performs one or more additional actions (e.g., shipping the fashion items 104a-c) in real-time after performing the transaction.

The web server 112 can receive the one or more resources 126 associated with the selected installment option 124 after fulfillment of the transaction. For example, the web server 112 can transmit a notification to the resource server 118 indicating that the transaction has been fulfilled (e.g., authorize purchase of the washing machine). In some instances, the resource server 118 provides the one or more resources 126 associated with the selected installment option 124 after confirming the one or more additional actions performed by the web server 112. For example, the resource server can provide the one or more resources after the e-commerce website confirms that the fashion items 104a-c have been delivered to the customer.

In some instances, the web server 112 receives a request to terminate the transaction. The termination can occur during or after the transaction. The request to terminate the transaction can include determining that the user device has: (i) canceled the transaction before fulfillment; (ii) requested a reimbursement associated with the transaction; or (iii) returned any items involved in the transaction. Continuing with the example, the customer may return the fashion items 104a-c to the retailer associated with the e-commerce website after a week of fulfilling the transaction. If the transaction is terminated, the web server 112 can return the resources 126 associated with the selected installment option 124 back to the resource server 118, and the resource server 118 can void the installment plan.

### B. System Components for Fulfilling Transactions Based on Resources Provided by a Resource Provider

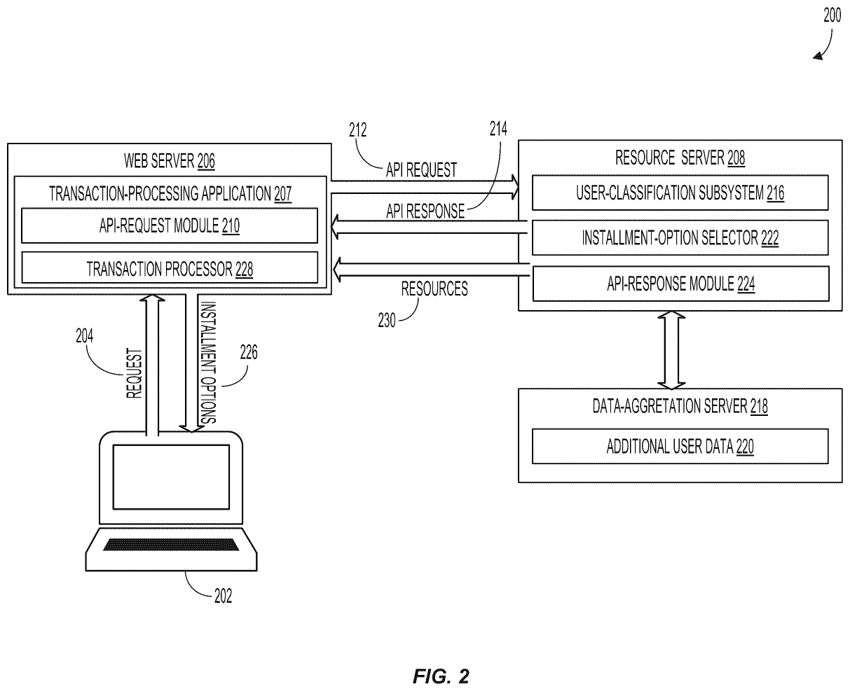

FIG. 2 illustrates an example system architecture 200 for fulfilling transactions based on resources provided by a resource provider, according to some embodiments. The system architecture 200 can include a client device 202 that is configured to submit a request 204 for a resource provider (e.g., a financial institution) to immediately fulfill the transaction, in exchange for the user reimbursing the resource provider across an extended time period. In some instances, the client device can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

The request 204 can include a request for an amount of resources that can be used for fulfilling the transaction. In some instances, the request 204 also includes user-profile data of the user. The request can be transmitted by the client device 202 using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. For example, the request 204 under an HTML protocol can be formatted as a GET request or a POST request. The user-profile data can include personally-identifiable information (PII) of a user, including name, address, age, social security number, credit score, date and place of birth, mother's maiden name, or biometric records associated with the user. The user-profile data can be analyzed by the resource server to determine whether or how the resources should be reimbursed by the user. In some instances, the PII of the user is anonymized and encrypted such that only the resource provider (and not the web server) can access the PII.

The resources for fulfilling the transaction can include any tangible or intangible assets that can be used to obtain a particular item or service. In some instances, a particular type of resources used to immediately fulfill the transaction is different from the type of resources used for reimbursing the resource provider over the extended time period. Additionally or alternatively, an amount of resources used to immediately fulfill the transaction is different from the amount of resources used for reimbursing the resource provider over the extended time period.

The request 204 can be transmitted by the client device 202 via one or more communication networks. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 202 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

A web server 206 can receive the request 204 from the client device 202. In some embodiments, the web server 206 operates as a standalone device or may be connected (e.g., networked) to other systems. In a networked deployment, the web server 206 can operate in the capacity of a server in a client-server network environment, or as a peer system in a peer-to-peer (or distributed) network environment. The web server 206 can be configured to fulfill the transaction upon receiving the corresponding resources associated with the transaction. In some embodiments, the web server 206 operates as a standalone device or may be connected (e.g., networked) to other systems. In a networked deployment, the system may operate in the capacity of a server or a client system in a client-server network environment, or as a peer system in a peer-to-peer (or distributed) network environment. In some instances, the corresponding resources are received from the client device 202. Additionally or alternatively, the corresponding resources can be received from a resource server 208.

The web server 206 can include various modules or components to interact with the resource server 208 to immediately fulfill the transaction. For example, the web server 206 can include a transaction-processing application 207 configured to fulfill transactions based on resources provided by the resource server 208. The transaction-processing application can include an API-request module 210, which is configured to dynamically construct an API request 212 based on the data included in the request 204. The API-request module 210 selects one or more portions of the user-profile data of the request 204 to construct the API request 212. The API requests can be constructed in real-time as the API-request module 210 continues to receive additional user-profile data from various users. The non-static, real-time features of processing the user-profile data may result in having the API request 212 that is different from other API requests that would be generated later in time (e.g., after 10 seconds, after 1 minute, after 5 minutes, after 30 minutes). For example, the one or more portions of the user-profile data can include name, date of birth, and social security number of the user. The API-request module 210 can additionally parse the user-profile data to determine presence of any errors. The errors can include data input that violate syntax rules associated with a corresponding data field of the user-profile data.

The web server 206 can transmit the API request 212 constructed by the API-request module 210 to the resource server 208. Prior to transmittal, the web server 206 can digitally sign and encrypt the API request 212 to protect its corresponding data from unauthorized access. Cryptographic protection (e.g., encryption) can thus be used to enhance the security of communication between the web server 206 and the resource server 208. For example, the web server 206 can generate a digital signature for the API request 212, encrypt the API request 212 to generate an encrypted request, and transmit the digital signature and the encrypted request to the resource server 208. In another example, the resource server 208 can generate and transmit a digital certificate to the web server 206. The web server can utilize the digital certificate to digitally sign the API request 212. The web server 206 can then transmit the digitally signed API request 212 to the resource server 208, such that the resource server 208 can authenticate the digitally signed API request 212.

In some instances, the user-profile data and any additional user data are accessed by the resource server 208 based on an authentication token generated by the web server 206 or other third-party systems. For example, after the user permits a third-party system (e.g., another financial institution, social-media platform) to share additional user data, the third-party system can issue the authentication token to the resource server 208. The resource server 208 can use the authentication token to access the user-profile data and the additional user data from the third-party system. The additional user data accessed from the web server 206 or the third-party system can allow the resource server 208 to perform a more accurate assessment of the user's capability of reimbursing the requested resources over the extended time period of time. In some instances, the use of authentication tokens increases a likelihood that the resource server 208 approves the installment options for the user.

The resource server 208 can analyze the API request 212 and generates a corresponding response message 214. In some embodiments, the resource server 208 operates as a standalone device or may be connected (e.g., networked) to other systems. In a networked deployment, the resource server 208 can operate in the capacity of a server in a client-server network environment, or as a peer system in a peer-to-peer (or distributed) network environment. The resource server 208 can be associated with the resource provider (e.g., a financial-services institution) that provides the resources for fulfilling the transaction. The resource server 208 can include various components for receiving the API request 212 forwarded by the web server 206, manage the API request 212 in real-time based on the user-profile data, distribute in real-time the resources to the web server if the API request 212 is approved, and implement in real-time an installment plan for the user to reimburse the resources over the extended time period of time (e.g., 24 months).

For example, the resource server 208 can include a user-assessment subsystem 216, which can process the user-profile data in the API request 212 in real-time and generate a score representative of the capability of the corresponding user in reimbursing the requested resources over the extended time period of time. The user-assessment subsystem 216 can assess the user's capability in real-time, as the resource server 208 continues to receive additional API requests from the web server. The non-static, real-time features of processing the user-profile data by the user-assessment subsystem 216 may result in having the assessment that are different from other assessments that would be determined later in time (e.g., after 10 seconds, after 1 minute, after 5 minutes, after 30 minutes).

For example, the assessment can include the user-assessment subsystem 216 analyzing the user-profile data, determining the creditworthiness of the user, and generating a score that represents the capability of the corresponding user in reimbursing the requested resources. The score can be generated within a numerical, alphabetical, or alphanumerical range specified by the resource server 208. For example, the score can be a credit score ranging between 300 and 800, in which the higher number indicates an increased likelihood of the user reimbursing the entirety of the requested resources. In another example, the score can range between 1 and 10, in which the lower number indicates an increased likelihood of the user reimbursing the entirety of the requested resources. In yet another example, the score can be a categorical value between A and F, in which the earlier-occurring alphabetical character (e.g., “A”) indicates an increased likelihood of the user reimbursing the entirety of the requested resource.

In some instances, the user-assessment subsystem 216 can utilize a machine learning algorithm or artificial intelligence to generate in real-time the score representative of the capability of the corresponding user in reimbursing the requested resources over the extended time period of time. The machine-learning algorithm generates the scores in real-time, as the resource server 208 continues to receive additional user-profile data associated with various users. The non-static, real-time features of using the machine-learning algorithms to generate the scores may result in having the score that are different from other scores of the user that would be determined later in time (e.g., after 10 seconds, after 1 minute, after 5 minutes, after 30 minutes). For instance, the user-assessment subsystem 216 may implement a clustering algorithm to identify similarly situated user based on one or more vectors (e.g., outstanding debt, spending patterns, available funds in accounts associated with the user, an amount of resources requested, indication of default). In some instances, a dataset of user-profile data associated with sample members (e.g., testers, etc.) may be analyzed using a clustering algorithm to identify different types of members that may interact with the web server 206. Example clustering algorithms that may trained using sample member datasets (e.g., historical member data, hypothetical member data, etc.) to classify a member in order to identify categories of tasks that may be of relevance to the member may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm generated using the user-profile data, the user-assessment subsystem 216 may generate the score that can be used to determine different installment options for reimbursing the requested resources.

Other examples of machine learning or artificial intelligence algorithms can also be used. For example, the machine-learning algorithms can include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

In some instances, the machine-learning algorithms are further trained based on a loss (e.g., a cross-entropy loss) determined between the scores generated for the users and outcomes associated with reimbursement of resources. For example, parameters of a machine-learning model (e.g., an artificial neural network) can be learned by processing the scores and reimbursement outcomes via a loss function (e.g., softmax function). Additionally or alternatively, the machine-learning algorithms can be trained based on an installment option selected by the user to reimburse the resources provided by the resource server 208. As a result, the machine-learning algorithms can be optimized to generate the scores that accurately reflects the creditworthiness of the user as well as determine installment options that maximize the chances of the user reimbursing the full amount of the resources provided by the resource provider.

Additionally or alternatively, the assessment can include the user-assessment subsystem 216 submitting a credit inquiry for the user. In some instances, the credit inquiry requested by the user-assessment subsystem is a “soft inquiry,” which does not affect the credit associated with the user. The user-assessment subsystem 216 can submit the credit inquiry to a data-aggregation server 218 (e.g., a credit-bureau agency), at which the data-aggregation server 218 can analyze the financial metrics (e.g., a credit score) of the user and determine a score that represents the capability of the corresponding user in reimbursing the requested resources. In some instances, the data-aggregation server 218 can utilize additional data 220 of the user to determine the score representative of the creditworthiness of the user. The additional user data 220 can include additional accounts associated with the user, previous transactions performed by the user, any debt associated with the user, and/or previous credit inquiries performed for the user. In some instances, the data-aggregation server 218 implements corresponding machine learning algorithm to generate the score, in which the machine-learning algorithm can be trained using additional data of other users.

Once the user-assessment subsystem 216 determines the score, the resource server 208 forwards the score to an installment-option selector 222. The installment-option selector 222 can include one or more data-processing rules to determine in real-time a set of installment options for reimbursing the request resources. The installment-option selector 222 can determine the set of installment options in real-time, as the installment-option selector 222 continues to receive additional user-profile data associated with various users. The non-static, real-time features of receiving and processing the user-profile data may result in determining the set of installment options that are different from other installment options that would be determined later in time (e.g., after 10 seconds, after 1 minute, after 5 minutes, after 30 minutes) for the user. In some instances, if additional user data was accessed using authentication tokens, the resource server 208 immediately approves the API request 212 and provide the set of installment options. The use of the authentication tokens associated with the user increases the likelihood of the user being approved for the set of installment options.

The set of installment options can include different arrangements for reimbursing the requested resources over an extended time period of time, in exchange for the resource server 208 to immediately provide the resources to the web server 206 to immediately fulfill the transaction. For example, the set of installment options can include an option for the user to submit a portion of the requested resources as a prerequisite to receiving the requested resources. As an illustrative example, if the resources for fulfilling the transaction equal to three hundred dollars, an installment option can include an initial payment of seventy-five dollars followed by three monthly payments seventy-five dollars. Additionally or alternatively, the set of installment options can include a denial of providing the requested resources but instead an approval associated with a portion of the requested resources. For example, if the resources for fulfilling the transaction equal to three hundred dollars, an installment option can include an approval for two hundred dollars. The set of installment options can also include an interest rate associated with each installment option and a repayment plan that specifies a portion of resources to be submitted at every interval (e.g., weekly, monthly) until the entirety of the resources are reimbursed to the resource server after a predetermined time period. An example interest rate can be determined from a range between 0.1 and 39.99%.

Once the installment options are determined by the installment-option selector 222, an API-response module 224 of the resource server 208 can dynamically generate and transmit an API-response message 214. The API-response message 214 can be formatted into a particular data structure (e.g., JSON, XML) that can be parsed and interpreted by the web server 206. In some instances, the response message 214 includes the set of installment options. For example, the API-response message 214 can be formatted in JSON, in which a name identifier (e.g., “options”) can be associated with an array of values corresponding to the set of installment options.

The resource server 208 can transmit the API-response message 214 to the web server 206. The web server 206 can receive and parse the API-response message 214 to identify a set of installment options 226 to be presented on the client device 202. To parse the API-response message 214, the web server 206 can extract key-value pairs of the API-response message 214 to identify the installment options 226. For example, the web server 206 can receive the API-response message 214 in a string format, convert the API-response message 214 into a data object (e.g., a JavaScript object) by executing one or more functions (e.g., JSON.parse( )), and process the data object to identify key-value pair that is associated the set of installment options. In some instances, the web server 206 is configured to initially identify a status code from the API-response message 214 and determine whether the API-response message 214 includes the installment options 226 based on the status code. For example, the API request module 210 can identify that the status code corresponds to a successful response “200”, at which the API request module 210 can proceed with parsing the API-response message 214. In another example, the API request module 210 can identify that the status code corresponds to an unauthorized request “401”, at which the web server 206 can generate an error message on the web browser of the client device 202.

The web server 206 can then associate the set of installment options 226 from the response message with a set of graphical user-interface elements. The set of graphical user-interface elements can then be presented on a display of the web browser of the client device 202. For example, the webpage associated with the web server can display the following user-interface elements: (i) a first user-interface element corresponding to a first installment option associated with securing an entire amount of the requested resources; (ii) a second user-interface element corresponding to a second installment option associated with a request for a user to submit a portion of the requested resources as a prerequisite for receiving the requested resources; and (iii) a third user-interface element corresponding to a third installment option associated with receiving a portion of the requested resources. Each user-interface element can thus include a code or script (e.g., a button associated with a POST submission) that dynamically triggers submission of the corresponding installment option once selected by the user.

The client device 202 can select an installment option from the set of installment options 226. The selection of the installment option indicates that the user of the client device 202 prefers the selected installment option over other installment options within the set. In some instances, the selection of the installment option is associated with a user interaction with a graphical user-interface element. The user interaction can include a user clicking a graphical user-interface element displayed on the web browser, in which the graphical user-interface element is associated with a particular installment option.

A transaction processor 228 of the transaction-processing application 207 can receive the selected installment option and forward the selected installment option to the resource server 208. In some instances, the transaction processor 228 can interact with the API-request module 210 to construct a subsequent API request that includes a user identifier associated with the user, the selected installment option, and an authorization for the resource server 208 to proceed with distributing the requested resources to the web server in accordance with the selected installment option. Similar to the API request 212, the API-request module 210 can construct the subsequent API request in real-time as the transaction processor 228 continues to receive additional selection of installment options from various users. In some instances, if the selected installment option requires a portion of the resources to be submitted as a prerequisite for securing the resources, the subsequent API request can include the portion of the resources submitted by the user. When the selected installment option is received at the resource server 208, the resource server 208 can transmit one or more resources 230 associated with the selected installment option.

In some instances, before further processing the selected installment option, the transaction processor 228 is configured to avail terms-and-conditions data associated with the selected installment option to the client device 202. The terms-and-conditions data can include information governing the contractual relationship between the resource provider of the resource server 208 and the user. In some instances, the resource server 208 provides the terms-and-conditions data associated with the selected installment option to the web server 206, at which the web server 206 can provide the terms-and-conditions data to the user. For example, the resource server 208 can populate a template document that includes the terms-and-conditions data with portions of the user-profile data, the selected installment options, and fields that request approval signatures or initials from the user.

The resource server 208, via the web server 206, can require the user to accept the terms-and-conditions data before transmitting the selected installment option to the resource server 208. The user can then determine whether to accept the information set forth in the terms-and-conditions data. If the user rejects the terms-and-conditions data, the transaction processor 228 can transmit a notification to the resource server 208 that the request for resources has been canceled. If the user accepts the terms-and-conditions data, the transaction processor 228 can proceed with transmitting a user-approval of the selected installment option to the resource server 208.

The transaction processor 228 can dynamically fulfill the transaction after transmitting the selected installment option. The transaction processor 228 can fulfill the transaction in real-time, as the web server continues to process other user-profile data, construct other API requests, process other installment options, and fulfill transactions from other users. In some instances, before the transaction processor 228 fulfills the transaction, the resource server 208 performs an additional credit inquiry on the user. The additional credit inquiry (e.g., a “hard” credit inquiry) can be a different inquiry type from the initial credit inquiry (e.g., a “soft” credit inquiry) used to select the set of installment options 225. In some instances, the additional credit inquiry is performed by the resource server 208 submitting the additional credit inquiry to the data-aggregation server 218, in which the data-aggregation server 218 can access the additional user data 220 to determine whether the user is eligible for the selected installment option. If the additional credit inquiry indicates that the user can proceed with the selected installment option, the resource server 208 can transmit an authorization to the transaction processor 228 to process with fulfilling the transaction.

The transaction processor 228 can authorize the purchase of the items after transmitting the selected installment option to the resource server 208. In some instances, to fulfill the transaction, the transaction processor 228 performs one or more additional actions (e.g., shipping the items) after performing the transaction. Once the transaction is completed, the transaction processor 228 can dynamically generate a notification to the resource server 208 indicating that the transaction has been fulfilled.

The web server 206 can receive the one or more resources 230 associated with the selected installment option after fulfillment of the transaction. As described above, the transaction processor 228 can transmit a notification to the resource server 208 indicating that the transaction has been fulfilled. The fulfillment of the transaction can include one or more actions specified by the resource provider of the resource server 208. The one or more actions can include, but not limited to, shipment of items associated with the transaction, initiation or completion of a service associated with the transaction (e.g., repair of certain items), and availing of computing services associated the transaction (e.g., availing media to be streamed on the client device 202, activation of cloud resources for the client device 202). For example, the resource server 208 can provide the one or more resources 230 after the web server 206 confirms that the items have been delivered to the customer.

In some instances, the client device 202 submits a request to terminate the transaction. The termination can occur anytime during or after the transaction. The request to terminate the transaction can include determining that the user device has: (i) canceled the transaction before fulfillment; (ii) requested a reimbursement associated with the transaction; or (iii) returned any items involved in the transaction. If the transaction is terminated, the web server 206 can return the resources 230 associated with the selected installment option back to the resource server 208, and the resource server 208 can void the installment plan.

### C. System Components and Special-Purpose Computer for Fulfilling Transactions Based on Resources Provided by a Resource Provider

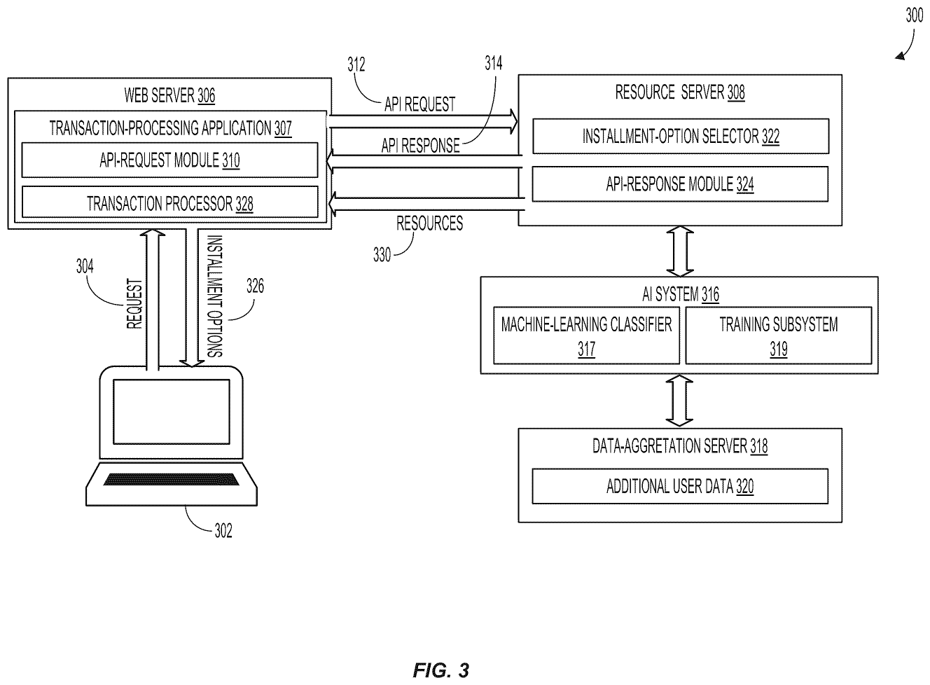

FIG. 3 illustrates an example system architecture 300 for fulfilling transactions based on resources provided by a resource provider, according to some embodiments. The system architecture 300 can include a client device 302 that is configured to submit a request 304 for a resource provider (e.g., a financial institution) to immediately fulfill the transaction, in exchange for the user reimbursing the resource provider across an extended time period. In some instances, the client device can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

The request 304 can include a request for an amount of resources that can be used for fulfilling the transaction. In some instances, the request 304 also includes user-profile data of the user. The request can be transmitted by the client device 302 using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. For example, the request 304 under an HTML protocol can be formatted as a GET request or a POST request. The user-profile data can include personally-identifiable information (PII) of a user, including name, address, age, social security number, credit score, date and place of birth, mother's maiden name, or biometric records associated with the user. The user-profile data can be analyzed by the resource server to determine whether or how the resources should be reimbursed by the user. In some instances, the PII of the user is anonymized and encrypted such that only the resource provider (and not the web server) can access the PII.

The resources for fulfilling the transaction can include any tangible or intangible assets that can be used to obtain a particular item or service. In some instances, a particular type of resources used to immediately fulfill the transaction is different from the type of resources used for reimbursing the resource provider over the extended time period. Additionally or alternatively, an amount of resources used to immediately fulfill the transaction is different from the amount of resources used for reimbursing the resource provider over the extended time period.

The request 304 can be transmitted by the client device 302 via one or more communication networks. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 302 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

A web server 306 can receive the request 304 from the client device 302. In some embodiments, the web server 306 operates as a standalone device or may be connected (e.g., networked) to other systems. In a networked deployment, the web server 306 can operate in the capacity of a server in a client-server network environment, or as a peer system in a peer-to-peer (or distributed) network environment. The web server 306 can be configured to fulfill the transaction upon receiving the corresponding resources associated with the transaction. In some embodiments, the web server 306 operates as a standalone device or may be connected (e.g., networked) to other systems. In a networked deployment, the system may operate in the capacity of a server or a client system in a client-server network environment, or as a peer system in a peer-to-peer (or distributed) network environment. In some instances, the corresponding resources are received from the client device 302. Additionally or alternatively, the corresponding resources can be received from a resource server 308.

The web server 306 can include various modules or components to interact with the resource server 308 to immediately fulfill the transaction. For example, the web server 306 can include a transaction-processing application 307 configured to fulfill transactions based on resources provided by the resource server 308. The transaction-processing application can include an API-request module 310, which is configured to dynamically construct an API request 312 based on the data included in the request 304. The API-request module 310 selects one or more portions of the user-profile data of the request 304 to construct the API request 312. The API requests can be constructed in real-time as the API-request module 310 continues to receive additional user-profile data from various users. The non-static, real-time features of processing the user-profile data may result in having the API request 312 that is different from other API requests that would be generated later in time (e.g., after 10 seconds, after 1 minute, after 5 minutes, after 30 minutes). For example, the one or more portions of the user-profile data can include name, date of birth, and social security number of the user. The API-request module 310 can additionally parse the user-profile data to determine presence of any errors. The errors can include data input that violate syntax rules associated with a corresponding data field of the user-profile data.

The web server 306 can transmit the API request 312 constructed by the API-request module 310 to the resource server 308. Prior to transmittal, the web server 306 can digitally sign and encrypt the API request 312 to protect its corresponding data from unauthorized access. Cryptographic protection (e.g., encryption) can thus be used to enhance the security of communication between the web server 306 and the resource server 308. For example, the web server 306 can generate a digital signature for the API request 312, encrypt the API request 312 to generate an encrypted request, and transmit the digital signature and the encrypted request to the resource server 308. In another example, the resource server 308 can generate and transmit a digital certificate to the web server 306. The web server can utilize the digital certificate to digitally sign the API request 312. The web server 306 can then transmit the digitally signed API request 312 to the resource server 308, such that the resource server 308 can decrypt or authenticate the digitally signed API request 312.

In some instances, the user-profile data and any additional user data are accessed by the resource server 308 based on an authentication token generated by the web server 306 or other third-party systems. For example, after the user permits a third-party system (e.g., another financial institution, social-media platform) to share additional user data, the third-party system can issue the authentication token to the resource server 308. The resource server 308 can use the authentication token to access the user-profile data and the additional user data from the third-party system. The additional user data accessed from the web server 306 or the third-party system can allow the resource server 308 to perform a more accurate assessment of the user's capability of reimbursing the requested resources over the extended time period of time. In some instances, the use of authentication tokens increases a likelihood that the resource server 308 approves the installment options for the user.

The resource server 308 can analyze the API request 312 and generates a corresponding response 314. In some embodiments, the resource server 308 operates as a standalone device or may be connected (e.g., networked) to other systems. In a networked deployment, the resource server 308 can operate in the capacity of a server in a client-server network environment, or as a peer system in a peer-to-peer (or distributed) network environment. The resource server 308 can be associated with the resource provider (e.g., a financial-services institution) that provides the resources for fulfilling the transaction. The resource server 308 can include various components for receiving the API request 312 forwarded by the web server 306, manage the API request 312 in real-time based on the user-profile data, distribute in real-time the resources to the web server if the API request 312 is approved, and implement in real-time an installment plan for the user to reimburse the resources over the extended time period of time (e.g., 34 months).

For example, the resource server 308 can transmit the user-profile data to an AI system 316, which can process the user-profile data in the API request 312 in real-time and generate a score representative of the capability of the corresponding user in reimbursing the requested resources over the extended time period of time. In some embodiments, the AI system 316 is implemented by a special purpose computer that is specifically configured to process the user-profile data and generate a score representative of the capability of the corresponding user in reimbursing the requested resources over the extended time period of time. Additionally, one or more components of the AI system 316 is implemented by another special purpose computer (e.g., a training subsystem 319) that is specifically configured to train the machine-learning model using an amount of historical data and applying the trained machine-learning algorithms. The AI system 316 generates the scores in real-time using the machine-learning model, as the resource server 308 continues to receive additional user-profile data associated with various users. The non-static, real-time features of using the machine-learning algorithms to generate the scores may result in having the score that are different from other scores of the user that would be determined later in time (e.g., after 10 seconds, after 1 minute, after 5 minutes, after 30 minutes).

For example, the assessment can include the AI system 316 analyzing the user-profile data, determining the creditworthiness of the user, and generating a score that represents the capability of the corresponding user in reimbursing the requested resources. The score can be generated within a numerical, alphabetical, or alphanumerical range specified by the resource server 308. For example, the score can be a credit score ranging between 300 and 800, in which the higher number indicates an increased likelihood of the user reimbursing the entirety of the requested resources. In another example, the score can range between 1 and 10, in which the lower number indicates an increased likelihood of the user reimbursing the entirety of the requested resources. In yet another example, the score can be a categorical value between A and F, in which the earlier-occurring alphabetical character (e.g., “A”) indicates an increased likelihood of the user reimbursing the entirety of the requested resource.

In some instances, a machine-learning classifier 317 of the AI system 316 can utilize a machine learning algorithm or artificial intelligence to generate in real-time the score representative of the capability of the corresponding user in reimbursing the requested resources over the extended time period of time. For instance, the AI system 316 may implement a clustering algorithm to identify similarly situated user based on one or more vectors (e.g., outstanding debt, spending patterns, available funds in accounts associated with the user, an amount of resources requested, indication of default). In some instances, a dataset of user-profile data associated with sample members (e.g., testers, etc.) may be analyzed using a clustering algorithm to identify different types of members that may interact with the web server 306. Example clustering algorithms that may trained using sample member datasets (e.g., historical member data, hypothetical member data, etc.) to classify a member in order to identify categories of tasks that may be of relevance to the member may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm generated using the user-profile data, the AI system 316 may generate the score that can be used to determine different installment options for reimbursing the requested resources.

Other examples of machine learning or artificial intelligence algorithms can also be used by the machine-learning classifier 317. For example, the machine-learning algorithms can include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

In some instances, the machine-learning classifier 317 is further trained based on a loss (e.g., a cross-entropy loss) determined between the scores generated for the users and outcomes associated with reimbursement of resources. For example, parameters of a machine-learning model (e.g., an artificial neural network) can be learned by processing the scores and reimbursement outcomes via a loss function (e.g., softmax function). Additionally or alternatively, the machine-learning classifier 317 can be trained based on an installment option selected by the user to reimburse the resources provided by the resource server 308. As a result, the machine-learning algorithms can be optimized to generate the scores that accurately reflects the creditworthiness of the user as well as determine installment options that maximize the chances of the user reimbursing the full amount of the resources provided by the resource provider.

Additionally or alternatively, the assessment can include the AI system 316 submitting a credit inquiry for the user. In some instances, the credit inquiry requested by the user-assessment subsystem is a “soft inquiry,” which does not affect the credit associated with the user. The AI system 316 can submit the credit inquiry to a data-aggregation server 318 (e.g., a credit-bureau agency), at which the data-aggregation server 318 can analyze the financial metrics (e.g., a credit score) of the user and determine a score that represents the capability of the corresponding user in reimbursing the requested resources. In some instances, the data-aggregation server 318 can utilize additional user data 320 of the user to determine the score representative of the creditworthiness of the user. The additional user data 320 can include additional accounts associated with the user, previous transactions performed by the user, any debt associated with the user, and/or previous credit inquiries performed for the user. In some instances, the data-aggregation server 318 implements a corresponding machine learning algorithm to generate the score, in which the machine-learning algorithm can be trained using additional data of other users.

Once the AI system 316 determines the score, the resource server 308 forwards the score to an installment-option selector 322. The installment-option selector 322 can include one or more data-processing rules to determine in real-time a set of installment options for reimbursing the request resources. The installment-option selector 322 can determine the set of installment options in real-time, as the installment-option selector 322 continues to receive additional user-profile data associated with various users. The non-static, real-time features of receiving and processing the user-profile data may result in determining the set of installment options that are different from other installment options that would be determined later in time (e.g., after 10 seconds, after 1 minute, after 5 minutes, after 30 minutes) for the user. In some instances, if additional user data was accessed using authentication tokens, the resource server 308 immediately approves the API request 312 and provide the set of installment options. The use of the authentication tokens associated with the user increases the likelihood of the user being approved for the set of installment options.

The set of installment options can include different arrangements for reimbursing the requested resources over an extended time period of time, in exchange for the resource server 308 to immediately provide the resources to the web server 306 to immediately fulfill the transaction. For example, the set of installment options can include an option for the user to submit a portion of the requested resources as a prerequisite to receiving the requested resources. As an illustrative example, if the resources for fulfilling the transaction equal to three hundred dollars, an installment option can include an initial payment of seventy-five dollars followed by three monthly payments seventy-five dollars. Additionally or alternatively, the set of installment options can include a denial of providing the requested resources but instead an approval associated with a portion of the requested resources. For example, if the resources for fulfilling the transaction equal to three hundred dollars, an installment option can include an approval for two hundred dollars. The set of installment options can also include an interest rate associated with each installment option and a repayment plan that specifies a portion of resources to be submitted at every interval (e.g., weekly, monthly) until the entirety of the resources are reimbursed to the resource server after a predetermined time period. An example interest rate can be determined from a range between 0.1 and 39.99%.

Once the installment options are determined by the installment-option selector 322, an API-response module 324 of the resource server 308 can dynamically generate and transmit an API-response message 314. The API-response message 314 can be formatted into a particular data structure (e.g., JSON, XML) that can be parsed and interpreted by the web server 306. In some instances, the API-response message 314 includes the set of installment options. For example, the API-response message 314 can be formatted in JSON, in which a name identifier (e.g., “options”) can be associated with an array of values corresponding to the set of installment options.

The resource server 308 can transmit the API-response message 314 to the web server 306. The web server 306 can receive and parse the API-response message 314 to identify a set of installment options 326 to be presented on the client device 302. To parse the API-response message 314, the web server 306 can extract key-value pairs of the API-response message 314 to identify the installment options 326. For example, the web server 306 can receive the API-response message 314 in a string format, convert the API-response message 314 into a data object (e.g., a JavaScript object) by executing one or more functions (e.g., JSON.parse( )), and process the data object to identify key-value pair that is associated the set of installment options. In some instances, the web server 306 is configured to initially identify a status code from the API-response message 314 and determine whether the API-response message 314 includes the installment options 326 based on the status code. For example, the API-request module 310 can identify that the status code corresponds to a successful response “200”, at which the API-request module 310 can proceed with parsing the API-response message 314. In another example, the API-request module 310 can identify that the status code corresponds to an unauthorized request “401”, at which the web server 306 can generate an error message on the web browser of the client device 302.

The web server 306 can then associate the set of installment options 326 from the response message with a set of graphical user-interface elements. The set of graphical user-interface elements can then be presented on a display of the web browser of the client device 302. For example, the webpage associated with the web server can display the following user-interface elements: (i) a first user-interface element corresponding to a first installment option associated with securing an entire amount of the requested resources; (ii) a second user-interface element corresponding to a second installment option associated with a request for a user to submit a portion of the requested resources as a prerequisite for receiving the requested resources; and (iii) a third user-interface element corresponding to a third installment option associated with receiving a portion of the requested resources. Each user-interface element can thus include a code or script (e.g., a button associated with a POST submission) that dynamically triggers submission of the corresponding installment option once selected by the user.

The client device 302 can select an installment option from the set of installment options 326. The selection of the installment option indicates that the user of the client device 302 prefers the selected installment option over other installment options within the set. In some instances, the selection of the installment option is associated with a user interaction with a graphical user-interface element. The user interaction can include a user clicking a graphical user-interface element displayed on the web browser, in which the graphical user-interface element is associated with a particular installment option.

A transaction processor 328 of the transaction-processing application 307 can receive the selected installment option and forward the selected installment option to the resource server 308. In some instances, the transaction processor 328 can interact with the API-request module 310 to construct a subsequent API request that includes a user identifier associated with the user, the selected installment option, and an authorization for the resource server 308 to proceed with distributing the requested resources to the web server in accordance with the selected installment option. Similar to the API request 312, the API-request module 310 can construct the subsequent API request in real-time as the transaction processor 328 continues to receive additional selection of installment options from various users. In some instances, if the selected installment option requires a portion of the resources to be submitted as a prerequisite for securing the resources, the subsequent API request can include the portion of the resources submitted by the user. When the selected installment option is received at the resource server 308, the resource server 308 can transmit one or more resources 330 associated with the selected installment option.

In some instances, before further processing the selected installment option, the transaction processor 328 is configured to avail terms-and-conditions data associated with the selected installment option to the client device 302. The terms-and-conditions data can include information governing the contractual relationship between the resource provider of the resource server 308 and the user. In some instances, the resource server 308 provides the terms-and-conditions data associated with the selected installment option to the web server 306, at which the web server 306 can provide the terms-and-conditions data to the user. For example, the resource server 308 can populate a template document that includes the terms-and-conditions data with portions of the user-profile data, the selected installment options, and fields that request approval signatures or initials from the user.

The resource server 308, via the web server 306, can require the user to accept the terms-and-conditions data before transmitting the selected installment option to the resource server 308. The user can then determine whether to accept the information set forth in the terms-and-conditions data. If the user rejects the terms-and-conditions data, the transaction processor 328 can transmit a notification to the resource server 308 that the request for resources has been canceled. If the user accepts the terms-and-conditions data, the transaction processor 328 can proceed with transmitting a user-approval of the selected installment option to the resource server 308.

The transaction processor 328 can dynamically fulfill the transaction after transmitting the selected installment option. The transaction processor 328 can fulfill the transaction in real-time, as the web server continues to process other user-profile data, construct other API requests, process other installment options, and fulfill transactions from other users. In some instances, before the transaction processor 328 fulfills the transaction, the resource server 308 performs an additional credit inquiry on the user. The additional credit inquiry (e.g., a hard credit inquiry) can be a different inquiry type from the initial credit inquiry (e.g., a soft credit inquiry) used to select the set of installment options 325. In some instances, the additional credit inquiry is performed by the resource server 308 submitting the additional credit inquiry to the data-aggregation server 318, in which the data-aggregation server 318 can access the additional user data 320 to determine whether the user is eligible for the selected installment option. If the additional credit inquiry indicates that the user can proceed with the selected installment option, the resource server 308 can transmit an authorization to the transaction processor 328 to process with fulfilling the transaction.

The transaction processor 328 can authorize the purchase of the items after transmitting the selected installment option to the resource server 308. In some instances, to fulfill the transaction, the transaction processor 328 performs one or more additional actions (e.g., shipping the items) after performing the transaction. Once the transaction is completed, the transaction processor 328 can generate a notification to the resource server 308 indicating that the transaction has been fulfilled.

The web server 306 can receive the one or more resources 330 associated with the selected installment option after fulfillment of the transaction. As described above, the transaction processor 328 can transmit a notification to the resource server 308 indicating that the transaction has been fulfilled. The fulfillment of the transaction can include one or more actions specified by the resource provider of the resource server 308. The one or more actions can include, but not limited to, shipment of items associated with the transaction, initiation or completion of a service associated with the transaction (e.g., repair of certain items), and availing of computing services associated the transaction (e.g., availing media to be streamed on the client device 302, activation of cloud resources for the client device 302). For example, the resource server 308 can provide the one or more resources 330 after the web ser 306 confirms that the items have been delivered to the customer.

In some instances, the client device 302 submits a request to terminate the transaction. The termination can occur anytime during or after the transaction. The request to terminate the transaction can include determining that the user device has: (i) canceled the transaction before fulfillment; (ii) requested a reimbursement associated with the transaction; or (iii) returned any items involved in the transaction. If the transaction is terminated, the web server 306 can return the resources 330 associated with the selected installment option back to the resource server 308, and the resource server 308 can void the installment plan.

### II. Methods for Fulfilling Transactions Based on Resources Provided by a Resource Provider

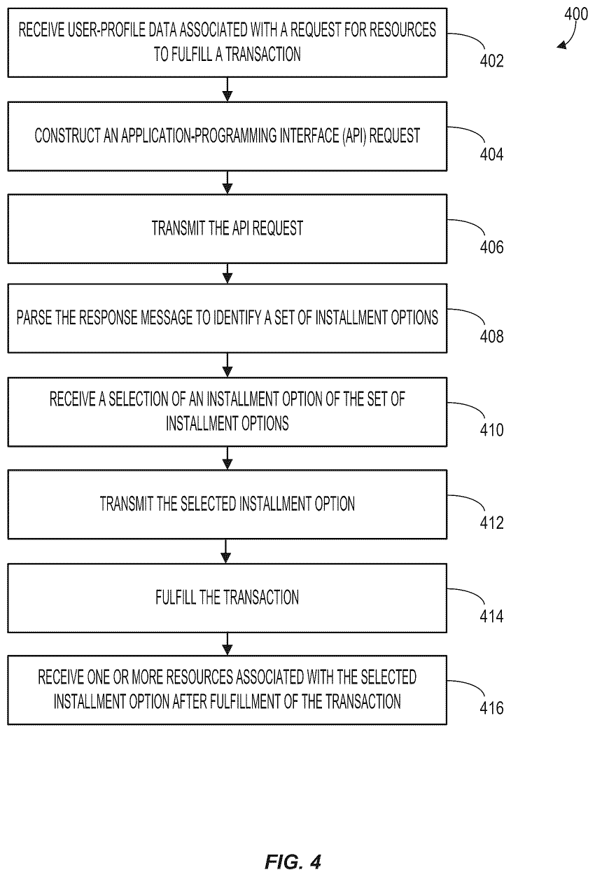

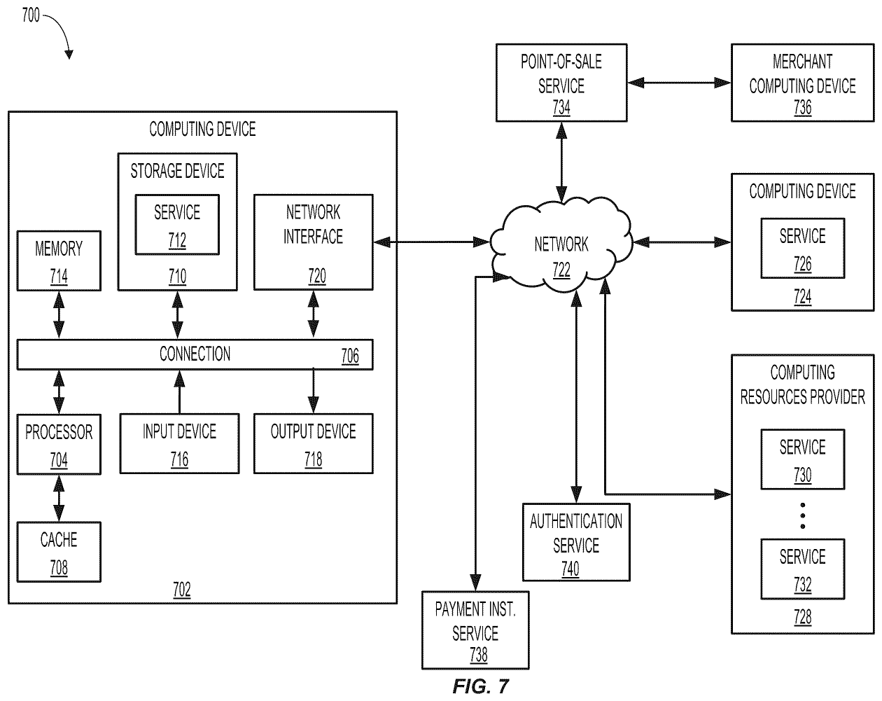

FIG. 4 shows an illustrative example of a process 400 for fulfilling transactions based on resources provided by a resource provider, in accordance with some embodiments. For illustrative purposes, the process 400 is described with reference to the components illustrated in FIGS. 2-3, though other implementations are possible. For example, the program code for the transaction-processing application 207 of FIG. 2, is executed by one or more processing devices to cause a server system (e.g., the computing device 702 of FIG. 7) to perform one or more operations described herein.

At step 402, a transaction-processing application of a web server receives user-profile data associated with a request for resources to immediately fulfill a transaction. The web server can be associated with a provider of goods or services (e.g., a cloud service provider, an e-commerce website). The transaction can include a purchase of items, a request to perform a particular service on behalf of the user, and the like. The transaction-processing application can fulfill the transaction in exchange for the goods or service provider being compensated with corresponding resources. Regarding the above situation, the user can submit a request for resources from a resource provider (e.g., a financial institution) to immediately fulfill the transaction, in exchange for the user reimbursing the resource provider across an extended time period.

In some instances, the user-profile data includes personally-identifiable information (PII) of a user, including any information that can be used to distinguish or trace an individual's identity. For example, PII of the user can include name, address, age, social security number, credit score, date and place of birth, mother's maiden name, or biometric records associated with the user. The user-profile data can be analyzed by the resource server to determine how the resources should be reimbursed. For example, the resource server can implement various aspects of an installment plan based on the user-profile data, including an amount of resources authorized for distribution (which may be different from the amount of requested resources), a time period for reimbursing the requested resources, deposits needed to secure the requested resources, and the like.

The resources for fulfilling the transaction can include any tangible or intangible assets that can be used to obtain a particular item or service. In some instances, a particular type of resources used to immediately fulfill the transaction is different from the type of resources used for reimbursing the resource provider over the extended time period. Additionally or alternatively, an amount of resources used to immediately fulfill the transaction is different from the amount of resources used for reimbursing the resource provider over the extended time period. For example, the resource provider may add interest to the principal amount of resources to be reimbursed by the user.

At step 404, the transaction-processing application dynamically constructs in real-time an application-programming interface (API) request based on the user-profile data. In particular, the API requests can be constructed in real-time as the web server continues to receive additional user-profile data from various users. The non-static, real-time features of processing the user-profile data may result in having the API request that is different from other API requests that would be generated later in time (e.g., after 10 seconds, after 1 minute, after 5 minutes, after 30 minutes). In some instances, the transaction-processing application constructs the API request in real-time by selecting one or more portions of the user-profile data (e.g., name, social security number) to construct the API request. In the event that the user-profile data include one or more erroneous data components, the transaction-processing application may generate an error message to be presented on a web page. For example, the transaction-processing application generates the error message in response to determining that the first name includes numerical characters. After receiving the error message, the user can resubmit the request for resources for fulling the transaction.

At step 406, the transaction-processing application transmits the API request. The transaction-processing application can transmit the API request to the resource server across a communication network, at which the resource server analyzes the API request. Prior to transmittal, the API request can be cryptographically protected from unauthorized access. The cryptographic protection ensures that the PII of the user-profile data is protected from unauthorized third-party access (e.g., packet sniffing). For example, the transaction-processing application can generate a digital signature for the API request, encrypt the API request to generate an encrypted request, and transmit the digital signature and the encrypted request. In another example, the resource server can generate and transmit a digital certificate to the web server. The web server can utilize the digital certificate to digitally sign the API request. The web server can then transmit the digitally signed API request to the resource server, such that the resource server can authenticate the digitally signed API request.

In some instances, the user-profile data and any additional user data are accessed by the resource server based on an authentication token generated by the web server or other third-party systems. For example, after the user permits a third-party system (e.g., another financial institution, social-media platform) to share additional user data, the third-party system can issue the authentication token to the resource server. The resource server can use the authentication token to access the user-profile data and the additional user data from the third-party system. The additional user data accessed from the web server or the third-party system can allow the resource server to perform a more accurate assessment of the user's capability of reimbursing the requested resources over the extended time period of time. In some instances, the use of authentication tokens increases a likelihood that the resource server approves the installment options for the user.

When the API request is received at the resource server, the resource server can dynamically generate and transmit a response message. In some instances, the response message includes a set of installment options. The set of installment options can include different arrangements for reimbursing the requested resources to the resource server over an extended time period of time, in exchange for the resource server to immediately provide the resources to the transaction-processing application to fulfill the transaction. For example, the set of installment options can include an option to provide an entirety of the requested resources to the transaction-processing application. In some instances, the set of installment options includes an option for a user to submit a portion of the requested resources as a prerequisite to receiving the requested resources. Additionally or alternatively, the set of installment options can include a denial of providing the requested resources but instead an approval associated with a portion of the requested resources. The set of installment options can also include an interest rate associated with each installment option and a repayment plan that specifies a portion of resources to be submitted at every interval (e.g., weekly, monthly) until the entirety of the resources are reimbursed to the resource server after a predetermined time period. In some instances, the resource server determines the set of installment options in real-time, as the resource server continues to receive additional user-profile data associated with various users. The non-static, real-time features of receiving and processing the user-profile data may result in determining the set of installment options that are different from other installment options that would be determined later in time (e.g., after 10 seconds, after 1 minute, after 5 minutes, after 30 minutes) for the user.

To determine the set of installment options, the resource server can process in real-time the user-profile data in the API request and assess in real-time the capability of the corresponding user in reimbursing the requested resources over the extended time period of time. The resource server can assess the user's capability in real-time, as the resource server continues to receive additional API requests from the web server. The non-static, real-time features of processing the user-profile data by the resource server may result in having the assessment that are different from other assessments that would be determined later in time (e.g., after 10 seconds, after 1 minute, after 5 minutes, after 30 minutes). In some instances, if additional user data was accessed using authentication tokens, the resource server immediately approves the API request and provide the set of installment options. The use of the authentication tokens associated with the user increases the likelihood of the user being approved for the set of installment options.

For example, the assessment can include the resource server analyzing in real-time the user-profile data, determining in real-time the creditworthiness of the user, and generating in real-time a score that represents the capability of the corresponding user in reimbursing the requested resources. Additionally or alternatively, the assessment can include submitting a credit inquiry for the user. The resource server can submit the credit inquiry to a data-aggregation server (e.g., a credit-bureau agency), at which the data-aggregation server can analyze the financial metrics (e.g., a credit score) of the user and transmit a score that represents the capability of the corresponding user in reimbursing the requested resources.

At step 408, the transaction-processing application receives and parses the response message to identify the set of installment options. The transaction-processing application can then associate the set of installment options from the response message with a set of graphical user-interface elements. The set of graphical user-interface elements can then be presented on a display of the webpage. For example, the webpage associated with the transaction-processing application can display the following user-interface elements: (i) a first user-interface element corresponding to a first installment option associated with securing an entire amount of the requested resources; (ii) a second user-interface element corresponding to a second installment option associated with a request for a user to submit a portion of the requested resources as a prerequisite for receiving the requested resources; and (iii) a third user-interface element corresponding to a third installment option associated with receiving a portion of the requested resources.

At step 410, the transaction-processing application receives a selection of an installment option from the user device. The selection of the installment option indicates that the user prefers the selected installment option over other installment options within the set. In some instances, the selection of the installment option is associated with a user interaction with a graphical user-interface element. The user interaction can include a user clicking a graphical user-interface element associated with a particular installment option. In some instances, the user interaction includes a user selecting the particular installment option from a drop-down menu associated with the set of installment options.

At step 412, the transaction-processing application dynamically transmits the selected installment option. In some instances, the transaction-processing application constructs in real-time a subsequent API request that includes a user identifier associated with the user, the selected installment option, and an authorization for the resource server to proceed with distributing the requested resources to the transaction-processing application in accordance with the selected installment option. Similar to the initial API request, the transaction-processing application can construct the subsequent API request in real-time as the web server continues to receive additional selection of installment options from various users. In some instances, if the selected installment option requires a portion of the resources to be submitted as a prerequisite for securing the resources, the subsequent API request can include the portion of the resources submitted by the user. When the selected installment option is received at the resource server, the resource server can transmit in real-time one or more resources associated with the selected installment option.

In some instances, before further processing the selected installment option, the transaction-processing application provides terms-and-conditions data associated with the selected installment option to the user. The terms-and-conditions data can include information governing the contractual relationship between the resource provider and the user. In some instances, the resource server provides the terms-and-conditions data associated with the selected installment option to the transaction-processing application, at which the transaction-processing application can provide the terms-and-conditions data to the user. The transaction-processing application can require the user to accept the terms-and-conditions data before transmitting the selected installment option to the resource server. The user can then determine whether to accept the information set forth in the terms-and-conditions data. If the user rejects the terms-and-conditions data, the transaction-processing application can transmit a notification to the resource server that the request for resources has been canceled. If the user accepts the terms-and-conditions data, the transaction-processing application can proceed with transmitting a user-approval of the selected installment option.

At step 414, the transaction-processing application dynamically fulfills the transaction after transmitting the selected installment option. The transaction-processing application can fulfill the transaction in real-time, as the web server continues to process other user-profile data, construct other API requests, process other installment options, and fulfill transactions from other users. For example, the transaction-processing application can authorize in real-time the purchase of the washing machine after transmitting the selected installment option to the resource server. The fulfillment of the transaction can include performing one or more additional actions (e.g., shipping the washing machine) in real-time after performing the transaction itself.

At step 416, the transaction-processing application receives the one or more resources associated with the selected installment option after fulfillment of the transaction. The transaction-processing application can transmit a notification to the resource server indicating that the transaction has been fulfilled (e.g., authorize purchase of the washing machine). In some instances, the resource server provides the one or more resources associated with the selected installment option after the one or more additional actions performed by the transaction-processing application. For example, the resource server can provide the one or more resources after the e-commerce website confirms that the washing machine has been delivered to the customer.

In some instances, the transaction-processing application receives a request to terminate the transaction. The termination can occur during or after the transaction. The request to terminate the transaction can include determining that the user device has: (i) canceled the transaction before fulfillment; (ii) requested a reimbursement associated with the transaction; or (iii) returned any items involved in the transaction. If the transaction is terminated, the transaction-processing application can return the resources associated with the selected installment option back to the resource server, and the resource server can void the installment plan. The process 400 can terminate thereafter.

### III. Training Machine-Learning Models for Processing User-Profile Data

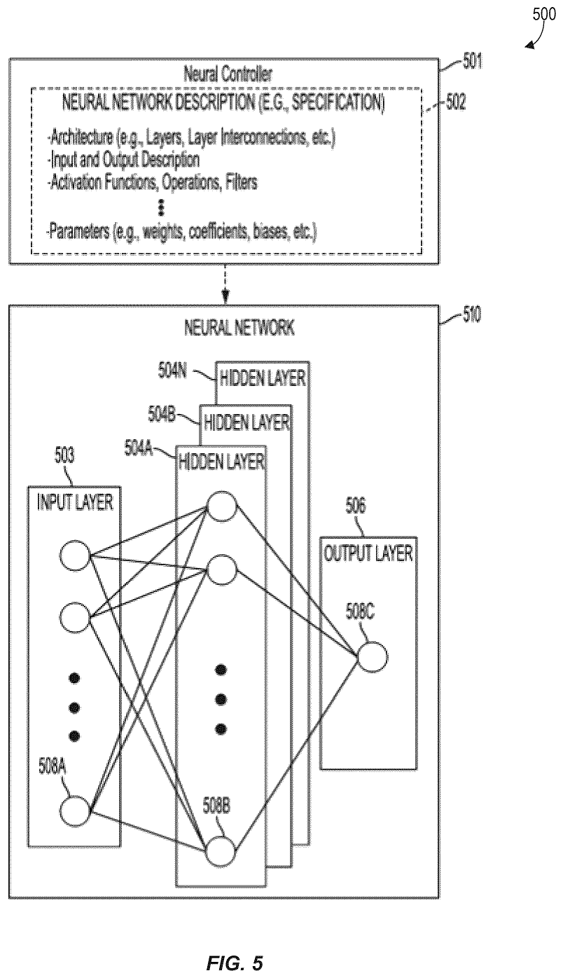

As described herein, a machine-learning model such as a clustering algorithm or a neural network can be trained to generate a score, which can then be used for determining a set of installment options to fulfill transactions. FIG. 5 illustrates an example architecture 500 of a neural network 510 for processing user-profile data, according to some embodiments. The neural network 510 defined by an example neural network description 502 for machine learning in a neural controller 501 (controller 501, which can be the same as a processing unit inside a mobile device). Neural network description 502 can include a full specification of the neural network 510, including the neural architecture 500. For example, the neural network description 502 can include a description or specification of architecture of the neural network 510 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

In one example, input description can include user-profile data (e.g., the user-profile data 114) and output description can be a score representative of the capability of the corresponding user in reimbursing the requested resources over the extended time period of time, as described above. For example, the score can be a credit score ranging between 300 and 800, in which the higher number indicates an increased likelihood of the user reimbursing the entirety of the requested resources. In another example, the score can range between 1 and 10, in which the lower number indicates an increased likelihood of the user reimbursing the entirety of the requested resources. In yet another example, the score can be a categorical value between A and F, in which the earlier-occurring alphabetical character (e.g., “A”) indicates an increased likelihood of the user reimbursing the entirety of the requested resource.

Various training and test data sets may be utilized to train the neural network 510 such that once trained, the neural network 510 can process various aspects of the user-profile data to determine the capability of the corresponding user in reimbursing the requested resources.

The neural network 510 can reflect the architecture 500 defined in neural network description 502. In this non-limiting example, the neural network 510 includes an input layer 503, which includes input data, which can be any type of data such as media content (images, videos, etc.), numbers, text, etc., associated with the user-profile data described above with reference to FIGS. 1-4. In one illustrative example, the input layer 503 can process data representing a portion of the input media data, such as a patch of data or pixels (e.g., a 128×128 patch of data) in an image corresponding to the input media data.

The neural network 510 can include hidden layers 504A through 504N (collectively “504” hereinafter). The hidden layers 504 can include n number of hidden layers, where n is an integer greater than or equal to one. The number of hidden layers can include as many layers as needed for a desired processing outcome and/or rendering intent. The neural network 510 further includes an output layer 506 that provides an output resulting from the processing performed by the hidden layers 504. In one illustrative example, an output layer 506 can provide the score (e.g., a credit score) to the neural network 510, in which the score represents the capability of the corresponding user in reimbursing the requested resources over the extended time period of time.

The neural network 510, in this example, is a multi-layer neural network of interconnected nodes. Each node can represent a piece of information. Information associated with the nodes is shared among the different layers and each layer retains information as information is processed. In some cases, the neural network 510 can include a feed-forward neural network, in which case there are no feedback connections where outputs of the neural network are fed back into itself. In other cases, the neural network 510 can include a recurrent neural network, which can have loops that allow information to be carried across nodes while reading in input.

Information can be exchanged between nodes through node-to-node interconnections between the various layers. Nodes of input layer 503 can activate a set of nodes in the first hidden layer 504A. For example, as shown, each input node of input layer 503 is connected to each node of first hidden layer 504A. Nodes of hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of output layer 506, at which point an output is provided. In some cases, while nodes (e.g., nodes 508A, 508B, 508C) in the neural network 510 are shown as having multiple output lines, a node has a single output and all lines shown as being output from a node represent the same output value. In examples described with reference to determining the score, the neural network 510, once trained, can have a single output that indicates the score at the output layer 506.

In some cases, each node or interconnection between nodes can have a weight that is a set of parameters derived from training the neural network 510. For example, an interconnection between nodes can represent a piece of information learned about the interconnected nodes. The interconnection can have a numeric weight that can be tuned (e.g., based on a training dataset), allowing the neural network 510 to be adaptive to inputs and able to learn as more data is processed.

The neural network 510 can be pre-trained to process the features from the data in the input layer 503 using different hidden layers 504 in order to provide the output through the output layer 506. For determining the creditworthiness of the user based on the user-profile data, the neural network 510 may be trained as follows.

A large pool of user-profile data may be split into two classes of data called training data set and test data set. For example, 70% of the user-profile data from the pool may be used as part of the training data set while the remaining 30% of the user-profile data from the pool may be used as part of the test data set. The percentages according to which the pool of user-profile data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The user-profile data can then be used to train the neural network 510 accompanied with manual feedback. With each score generated by the neural network 510, manual feedback can be provided to correct the output of the neural network 510, confirm the output of the neural network 510, etc. As noted, weights of different nodes of the neural network 510 may be adjusted/tuned during the training process to improve resulting output.

Once trained, the neural network 510 can be tested using user-profile data in test data set. Once the result of testing the neural network 510 is satisfactory (e.g., when outputs of the testing stage is greater than or equal to a threshold or incorrect detections are less than a threshold), the trained neural network 510 (which may also be referred to as a trained machine learning model or machine trained neural network) may be deployed for generating the score, which in turn can be used to determine the set of installment options for reimbursing the requested resources over an extended period of time.

In some cases, the neural network 510 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned.

For example, the forward pass can include passing a training image that represent a portion of the user-profile data through the neural network 510. The weights can be initially randomized before the neural network 510 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

The neural network 510 can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 510 can represent any other neural or deep learning network, such as an autoencoder, a deep belief nets (DBNs), a recurrent neural networks (RNNs), etc.

Neural Architecture Search (NAS) involves a process in which neural controller 501 searches through various types of neural networks such as CNNs, DBNs, RNNs, etc., to determine which type of neural network, given the input/output description of neural network description 502, can perform closes to the desired output once trained. This search process is currently cumbersome and resource intensive, because every type of available neural network is treated as a “blackbox.” In other words, a neural controller such as neural controller 501 selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

### IV. Example API Requests and Responses for Fulfilling Transactions Based on Resources

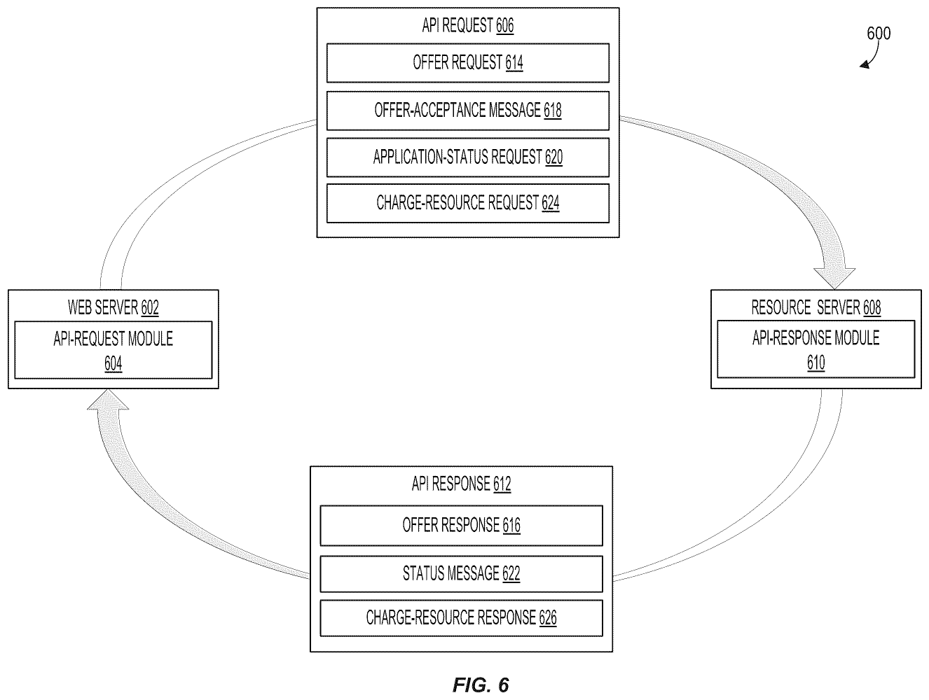

FIG. 6 illustrates an example schematic diagram 600 that shows example API requests and responses, according to some embodiments. As described in FIGS. 1-3, a web server 602 can receive a request for the resource provider to immediately fulfill the transaction. The request can be generated and transmitted by a user. The web server 602 can be associated with a service provider, a retailer, or any other merchant entity that fulfills transactions in exchange for receiving resources. The request can include an amount of resources that can be used for fulfilling the transaction. For the resource provider to fulfill the transaction, the request includes user-profile data of the user. The user-profile data can include personally-identifiable information (PII) of a user, including any information that can be used to distinguish or trace an individual's identity. For example, PII of the user can include name, address, age, social security number, credit score, date and place of birth, mother's maiden name, or biometric records associated with the user. The user-profile data can be analyzed by the resource server to determine whether or how the resources should be reimbursed over an extended period of time.

The web server 602 can include an API-request module 604 to dynamically construct an API request 606 based on the user-profile data. APIs can include mechanisms that enable two different servers (e.g., a resource server, a web server) to communicate with each other using a set of definitions and protocols. The API-request module 604 selects one or more portions of the user-profile data of the request to construct the API request 606. For example, the one or more portions of the user-profile data can include name, date of birth, and social security number of the user. The API-request module 604 can additionally parse the user-profile data to determine presence of any errors. The errors can include data input that violate syntax rules associated with a corresponding data field of the user-profile data.

A resource server 608 can be associated with a resource provider (e.g., a financial-services institution) that provides the resources for fulfilling the transaction. The resource server 608 can be configured to receive the request for resources forwarded by the web server 602, manage the request for resources in real-time based on the user-profile data, distribute in real-time the resources to the web server if the request is approved, and implement in real-time an installment plan for the user to reimburse the resources over the extended time period of time (e.g., 24 months).

When the API request 606 is received at the resource server 608, an API-response module 610 the resource server 608 can dynamically generate and transmit an API response 612. For example, the API response 612 can include the set of installment options, which include different arrangements for the user to reimburse the requested resources to the resource server over an extended time period of time. The API-response module 610 can format the API response 612 into a particular data structure (e.g., JSON, XML) that can be parsed and interpreted by the web server 602.

Continuing with FIG. 6, FIG. 6 provides non-exhaustive examples of: (i) the API requests the web server 602 can transmit to fulfill the transactions in exchange for resources provided by the resource server 608; and (ii) the API responses the resource server 608 can provide in response to the API requests submitted by the web server 602. As an example, the API request 606 can include an offer request 614. The web server 602 can submit the offer request 614 to screen customers based on their credit worthiness and allow a prospective card holder to apply for an installment application provided by the resource server 608. In particular, the offer request 614 can be used to forward the user-profile data to the resource server 608 to process the installment application. The offer request 614 can include: (i) a tracking identifier used to identify the particular request submitted by the user; (ii) merchant data associated with the web server 602; (iii) applicant data corresponding to the user-profile data of the user; and (iv) a purchase amount that includes the amount the user is requesting to fulfill the transaction. In some instances, the merchant data includes an identifier of the merchant and a product identifier that is associated with one or more products associated with the transaction. The applicant data can include the name, address, social security number, date of birth, contact information, IP address, and other information that can be used to assess the user's creditworthiness of receiving the installment options. Additionally or alternatively, the offer request 614 can include financial-instrument data that identifies information associated with a financial instrument (e.g., a credit card) to be used for the transaction. The resource server 608 can then process the financial-instrument data to identify if there are any types of promotions that can be applied to the set of installment options. An example data schema of the offer request 614 can be provided as follows:

```
“offerRequest”: {
    “required”: [
      “applicationRefId”,
      “merchantInfo”,
      “purchaseAmount”
    ],
    “type”: “object”,
    “properties”: {
      “merchantInfo”: {
        “$ref”: “#/components/schemas/merchantInfoType”
      },
      “applicantInfo”: {
        “$ref”: “#/components/schemas/applicantInfoType”
      },
      “promotionInfo”: {
        “$ref”: “#/components/schemas/promotion”
      },
      “accountManagement”: {
        “$ref”: “#/components/schemas/accountManagementInfo”
      },
      “purchaseAmount”: {
        “pattern”: “\hat{ }$|\hat{ }(\\d{1,12})(?:\\.(\\d{1,2}))?$”,
        “type”: “string”,
        “description”: “The purchase amount which the applicant is
attempting to make.”,
        “example”: “560.99”
      },
      “applicationRefId”: {
        “pattern”: “\hat{ }[a-zA-Z0-9-_.]{16,40}$”,
        “type”: “string”,
        “description”: “Application Reference identifier is the unique
number for each application provided by Synchrony Partner to
Synchrony.”,
        “example”: “U398KJ255E.QIB6-6YAN_N77BQ88”
      }
    }
  }
```

In response to receiving the offer request 614, the API-response module 610 of the resource server 608 can generate an offer response 616. In particular, the API-response module 610 can analyze the merchant data, the applicant data, and the purchase amount associated with the tracking identifier to generate the offer response 616 that includes a set of installment options for the user. For example, the offer response 616 can include the following: (i) a decision message that indicates whether the applicant has been qualified for the installment options; (ii) an application identifier associated with the offer request 614; (iii) a reason code that includes information regarding approval or conditional approval of the offer request 614; (iv) an amount of resources (e.g., a credit limit) approved for the offer request 614; and (v) a set of installment options that include different arrangements for the user to reimburse the requested resources to the resource server over an extended time period of time. In some instances, each installment option of the set of installment options can be associated with an installment identifier (e.g., an offerCode) to allow the resource server 608 to identify the installment option that would be selected by the user. An example data schema of the offer response 616 can be provided as follows:

```
“offerResponse”: {
    “type”: “object”,
    “properties”: {
      “decisionCode”: {
        “type”: “string”,
        “description”: “Application Decision Code.”,
        “example”: “0010”,
        “enum”: [
          “0010”,
          “0006”,
          “0012”
        ]
      },
      “decisionMessage”: {
        “type”: “string”,
        “description”: “Application Decision.”,
        “example”: “CONDITIONALLY APPROVED”,
        “enum”: [
          “CONDITIONALLY APPROVED”,
          “DECLINED”,
          “NON FRAUD REFERRAL”
        ]
      },
      “applicationId”: {
        “maxLength”: 12,
        “pattern”: “\hat{ }[a-zA-Z0-9]{0,12}$”,
        “type”: “string”,
        “description”: “Unique Application Identifier from Synchrony to
Partner.”,
        “example”: “10KABC”
      },
      “reasonCode”: {
        “maxLength”: 4,
        “pattern”: “\hat{ }[a-zA-Z0-9]{0,4}$”,
        “type”: “string”,
        “description”: “Returned when an application is conditionally
approved.”,
        “example”: “ARIL”
      },
      “initialPayment”: {
        “pattern”: “\hat{ }$|\hat{ }[0-9]{1,5}$”,
        “type”: “string”,
        “description”: “initial payment.”,
        “example”: “309”
      },
      “loanAmount”: {
        “maxLength”: 15,
        “pattern”: “\hat{ }(\\d+)(?:\\.(\\d{1,2}))?$”,
        “type”: “string”,
        “description”: “Credit limit approved on installment
        application.”,
        “example”: “4500”
      },
      “OfferInfo”: {
        “$ref”: “#/components/schemas/offerInfoType”
      }
    },
    “description”: “This object contains installments offer information”
  }
```

As another example, the API request 606 can include an offer-acceptance message 618. In particular, if the offer response 616 indicates that the offer request 614 is approved and the user selects one of the set of installment options, the API-request module 604 can dynamically generates and transmits the offer-acceptance message 618, such that the resource server 608 can process the selected installment option and provide the requested resources to the web server 602. In some instances, the user provides the application identifier and the installment identifier provided by the offer response 616 to facilitate processing of the selected installment option. The offer-acceptance message 618 can include the following: (i) the installment identifier associated with the selected installment option; (ii) the merchant data associated with the web server 602; (iii) payment data that can be used to process any prepayment deposits associated with the selected installment option. As described above, the merchant data can include the identifier of the merchant and the product identifier that is associated with one or more products associated with the transaction. In response to receiving the offer-acceptance message 618, the resource server 608 can provide a confirmation message (e.g., “202” code) of the offer acceptance and an URL that can used to monitor the status of the disbursement of the resources. An example data schema of the offer-acceptance message 618 can be provided as follows:

```
“offerAcceptanceRequest”: {
    “required”: [
      “offerCode”
    ],
    “type”: “object”,
    “properties”: {
      “storeNumber”: {
        “maxLength”: 10,
        “pattern”: “\hat{ }$|\hat{ }[0-9]{10}$”,
        “type”: “string”,
        “description”: “Store Number provided by SYF. This can also be
supported as custom attribute at application level.”,
        “example”: “0000000001”
      },
      “operator”: {
        “maxLength”: 8,
        “pattern”: “\hat{ }$|\hat{ }[a-zA-Z0-9]{1,8}$”,
        “type”: “string”,
        “description”: “POS:Point of sale integration; INTERNET:For
atHome/Internet credit Applications. For internal Synchrony channels pass
the channel id. This can also be supported as custom attribute at
application level.”,
        “example”: “INTERNET”
      },
      “offerCode”: {
        “maxLength”: 19,
        “pattern”: “\hat{ }$|\hat{ }[a-zA-Z0-9]{1,19}$”,
        “type”: “string”,
        “description”: “offerCode provided by Synchrony while
returning Offers.”,
        “example”: “L1D”
      },
      “originalProductCode”: {
        “maxLength”: 3,
        “pattern”: “\hat{ }$|\hat{ }[0-9]{3}$”,
        “type”: “string”,
        “description”: “Account Type Product Code. Supports 150, 160,
600, & 650. This can also be supported as custom attribute at application
level.”,
        “example”: “550”
      },
      “paymentInfo”: {
        “$ref”: “#/components/schemas/paymentInfo”
      }
    }
  }
```

As another example, the API request 606 can include an application-status request 620. In particular, the web server 602 can generate the application-status request 620 to obtain status of the installment application from the resource server 608. The application-status request 620 can include the following information: (i) the application identifier associated with the application; and (ii) the merchant data associated with the web server 602.

In response to receiving the application-status request 620, the API-response module 610 of the resource server 608 can generate a status message 622. The status message can include status information regarding the offer request 614, including the following: (i) the application identifier associated with the offer request 614; (ii) a decision message associated with the offer request 614; (iii) a number of available payment retries; (iv) a deposit amount needed to process the installment option; (v) an amount of resources authorized for disbursement to the web server 602; (vi) the set of installment options and their associated offer identifiers; and (vii) account data associated with the user. The decision message can include different messages associated with the pending status of the offer request 614, including a conditional approval of the offer request 614, a success or failure message corresponding to the initial deposit, and a decline of the offer request 614. An example data schema of the status message 622 can be provided as follows:

```
“lookupResponse”: {
    “required”: [
      “applicationId”,
      “decisionCode”,
      “decisionMessage”
    ],
    “type”: “object”,
    “properties”: {
      “decisionCode”: {
        “type”: “string”,
        “description”: “Application Decision Code.”,
        “example”: “0010”,
        “enum”: [
          “0010”,
          “0006”,
          “0012”,
          “3001”,
          “4001”
        ]
      },
      “decisionMessage”: {
        “type”: “string”,
        “description”: “Application Decision.”,
        “example”: “CONDITIONALLY APPROVED”,
        “enum”: [
          “CONDITIONALLY APPROVED”,
          “DECLINED”,
          “NON FRAUD REFERRAL”,
          “INITIAL PAYMENT FAILED”,
          “AUTOPAY REGISTRATION FAILED”,
          “APPROVED”,
          “DECLINED PREVIOUSLY PROCESSED”,
          “DECLINED NO HIT”,
          “FRAUD INTERNET”,
          “APPLICATION QUEUED”
        ]
      },
      “applicationId”: {
        “maxLength”: 12,
        “pattern”: “\hat{ }[a-zA-Z0-9]{0,12}$”,
        “type”: “string”,
        “description”: “Unique Application Identifier from Synchrony to
Partner.”,
        “example”: “10KABC”
      },
      “availablePaymentRetries”: {
        “maxLength”: 1,
        “pattern”: “\hat{ }$|\hat{ }[0-9]{1}$”,
        “type”: “string”,
        “description”: “Available payment retries will be available and
returned along with decision code - 3001, only if Initial Payment is
failed.”,
        “example”: “3”
      },
      “reasonCode”: {
        “maxLength”: 4,
        “pattern”: “\hat{ }[a-zA-Z0-9]{0,4}$”,
        “type”: “string”,
        “description”: “Returned when an application is conditionally
approved.”,
        “example”: “ARIL”
      },
      “initialPayment”: {
        “pattern”: “\hat{ }$|\hat{ }[0-9]{1,5}$”,
        “type”: “string”,
        “description”: “initial Payment.”,
        “example”: “309”
      },
      “loanAmount”: {
        “maxLength”: 15,
        “pattern”: “\hat{ }(\\d+)(?:\\.(\\d{1,2}))?$”,
        “type”: “string”,
        “description”: “Credit limit approved on installment
        application.”,
        “example”: “4500”
      },
      “offerInfo”: {
        “$ref”: “#/components/schemas/offerInfoType”
      },
      “accountInfo”: {
        “$ref”: “#/components/schemas/accountInfoType”
      }
    },
    “description”: “This object contains application status information.
At any point of time, look up response will either return offerInfo or
accountInfo but not both.”
  },
```

The API request 606 can include a charge-resource request 624. The charge-resource request 624 can include a request to charge or cancel installment loan account based on the fulfillment status of the transaction. For example, if the transaction is fulfilled and one or more additional actions (e.g., shipping of purchased items) are completed, the charge-resource request 624 can include a request for a full amount of the requested resources. In another example, if the transaction is fulfilled but one or more additional actions are not completed, the charge-resource request 624 can include a request for a partial amount of the requested resources. In the event of the cancellation of the transaction, the charge-resource request 624 can indicate that no resources are to be provided. The charge-resource request 624 can include the following information: (i) the merchant data associated with the web server 602; (ii) account data associated with the installment option including account number and type of the installment option; and (iii) a status message of any additional actions including completion of the action, partial completion of the action, or cancellation of the offer request 614. In response to receiving the application-status request 620, the API-response module 610 of the resource server 608 can generate a charge-resource response 626. The charge-resource response 626 can indicate a status of the disbursement of resources. An example data schema of the charge-resource request 624 can be provided as follows:

```
“chargeLoanRequest”: {
    “required”: [
      “orderInfo”
    ],
    “type”: “object”,
    “properties”: {
      “merchantInfo”: {
        “$ref”: “#/components/schemas/merchantInfoType”
      },
      “loanAccountInfo”: {
        “$ref”: “#/components/schemas/loanAccountInfoType”
      },
      “orderInfo”: {
        “$ref”: “#/components/schemas/orderInfoType”
      },
      “purchaseType”: {
        “pattern”: “\hat{ }$|\hat{ }[a-zA-Z]{3,10}$”,
        “type”: “string”,
        “description”: “Field indicating the installment loan purchase
type.”
      }
    }
  },
```

### V. Example Systems

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In an embodiment, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed payment instrument service, the systems of the payment instrument service, and the systems and methods for dynamically, and in real-time, detecting transactions associated with available payment instruments and generating, in response, tokenized payment instruments corresponding to these available payment instruments can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with an obtained invoice described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real-time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described herein, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., Vx Works®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

In an embodiment, the computing device 702 can be connected to one or more additional computing devices and/or services such as merchant computing device 736 and/or a point-of-sale service 734 via the network 722 and using a connection such as the network interface 720. In an embodiment, the point-of-sale service 734 is separate from the merchant computing device 736. In an embodiment, the point-of-sale service 734 is executing on the merchant computing device 736. In an embodiment, the point-of-sale service 734 is executing as one or more services (e.g., the service 730 and/or the service 732) operating within the environment of the computing resources provider. As used herein, a point-of-sale service 734 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 736 to interact with the point-of-sale service 734. In an embodiment, the merchant computing device 736 is a dedicated point-of-service (POS) terminal. In an embodiment, the merchant computing device 736 is a cash register system. In an embodiment, the merchant computing device 736 is an application or web service operating on a computing device such as the computing device 702 described herein. In such an embodiment, the application or web service may be provided by a financial services system (e.g., a bank, a transaction processing system, an inventory management system, or some other such financial services system). In an embodiment, the merchant computing device 736 includes an auxiliary device or system to execute tasks associated with the point-of-sale service 734 (e.g., a payment instrument processing device attached to a smart phone or tablet). In an embodiment, the merchant computing device 736 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 736 is a virtual device (e.g., a virtual kiosk) such as the virtual devices described herein. Although not illustrated here, in an embodiment, the merchant computing device 736 may be one of a plurality of devices that may be interconnected using a network such as the network 722.

In an embodiment, the computing device 702 can be connected to one or more additional computing devices and/or services such as a payment instrument service 738 via the network 722 and using a connection such as the network interface 720. In an embodiment, the payment instrument service 738 connects directly with the point of sale service 734. In an embodiment, elements of the payment instrument service 738 are executing on the merchant computing device 736. In an embodiment, the payment instrument service 738 is executing as one or more services (e.g., the service 730 and/or the service 732) operating within the environment of the computing resources provider. As used herein, a payment instrument service 738 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 738 are running as an application or web service operating on a computing device such as the computing device 702 described herein. In such an embodiment, the application or web service of the payment instrument service 738 may be provided by a financial services system (e.g., a bank, a transaction processing system, an inventory management system, or some other such financial services system). In an embodiment, elements of the payment instrument service 738 are running on an auxiliary device or system configured to execute tasks associated with the payment instrument service 738 (e.g., uses a payment instrument processing device attached to a smart phone or tablet). In an embodiment, elements of the payment instrument service 738 are running on virtual device such as those described herein. Although not illustrated here, in an embodiment, the payment instrument service 738 may be running on one or more of a plurality of devices that may be interconnected using a network such as the network 722.

In an embodiment, the computing device 702 can be connected to one or more additional computing devices and/or services such as an authentication service 740 via the network 722 and using a connection such as the network interface 720. In an embodiment, the authentication service 740 is an element of the payment instrument service 738. In an embodiment, the authentication service 740 is separate from the payment instrument service 738. In an embodiment, the authentication service 740 connects directly with the point of sale service 734. In an embodiment, elements of the authentication service 740 are executing on the merchant computing device 736. In an embodiment, the authentication service 740 is executing as one or more services (e.g., the service 730 and/or the service 732) operating within the environment of the computing resources provider. As used herein, an authentication service 740 is a service used by one or more merchants to authenticate transactions associated with payment instruments. An authentication service may be a third-party service that provides secure and verified authorization of the transactions.

In an embodiment, elements of the authentication service 740 are running as an application or web service operating on a computing device such as the computing device 702 described herein. In such an embodiment, the application or web service of the authentication service 740 may be provided by a financial services system (e.g., a bank, a transaction processing system, an inventory management system, or some other such financial services system). In an embodiment, elements of the authentication service 740 are running on an auxiliary device or system configured to execute tasks associated with the authentication service 740 (e.g., provides authentication using payment instrument processing device attached to a smart phone or tablet). In an embodiment, elements of the authentication service 740 are running on virtual device such as those described herein. Although not illustrated here, in an embodiment, the authentication service 740 may be running on one or more of a plurality of devices that may be interconnected using a network such as the network 722.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method comprising:
receiving user-profile data associated with a request for resources to fulfill a transaction;
constructing an application-programming interface (API) request based on the user-profile data;
transmitting the API request, wherein when the API request is received at a resource server, the resource server dynamically generates and transmits a response message;
parsing the response message to identify a set of installment options;
associating the set of installment options with a set of graphical user-interface elements;
receiving a selection of an installment option, wherein the selection of the installment option is associated with a user interaction with a graphical user-interface element;
transmitting the selected installment option, wherein when the selected installment option is received at the resource server, the resource server authorizes transmittal of one or more resources associated with the selected installment option;
fulfilling the transaction after transmitting the selected installment option; and
receiving the one or more resources associated with the selected installment option after fulfillment of the transaction.

2. The computer-implemented method of claim 1, wherein constructing the API request includes:
parsing the user-profile data to determine that the user-profile data include one or more erroneous data components; and
generating an error message to be presented on a web page.

3. The computer-implemented method of claim 1, wherein the set of installment options includes an option for a user to submit a portion of the requested resources to the resource server before receiving the requested resources.

4. The computer-implemented method of claim 1, wherein the set of installment options includes an option to immediately acquire the requested resources.

5. The computer-implemented method of claim 1, wherein the set of installment options includes a denial of providing the requested resources but instead an approval associated with a portion of the requested resources.

6. The computer-implemented method of claim 1, wherein transmitting the API request includes:
generating a digital signature for the API request;
encrypting the API request to generate an encrypted request; and
transmitting the digital signature and the encrypted request.

7. The computer-implemented method of claim 1, wherein the response message is generated based on a score generated by a data-aggregation server.

8. The computer-implemented method of claim 1, further comprising:
accessing terms-and-conditions data associated with the selected installment option before transmitting the selected installment option; and
transmitting the terms-and-conditions data, wherein when a user device receives the terms-and-conditions data, the user device transmits an acceptance of the terms-and-conditions data.

9. The computer-implemented method of claim 1, further comprising:
receiving a request to terminate the transaction; and
transmitting the one or more resources associated with the selected installment option when the request to terminate the transaction is received.

10. A system, comprising:
one or more processors; and
memory storing thereon instructions that, as a result of being executed by the one or more processors, cause the system to perform operations comprising:
receiving user-profile data associated with a request for resources to fulfill a transaction;
constructing an application-programming interface (API) request based on the user-profile data;
transmitting the API request, wherein when the API request is received at a resource server, the resource server dynamically generates and transmits a response message;
parsing the response message to identify a set of installment options;
associating the set of installment options with a set of graphical user-interface elements;
receiving a selection of an installment option, wherein the selection of the installment option is associated with a user interaction with a graphical user-interface element;
transmitting the selected installment option, wherein when the selected installment option is received at the resource server, the resource server authorizes transmittal of one or more resources associated with the selected installment option;
fulfilling the transaction after transmitting the selected installment option; and
receiving the one or more resources associated with the selected installment option after fulfillment of the transaction.

11. The system of claim 10, wherein constructing the API request includes:
parsing the user-profile data to determine that the user-profile data include one or more erroneous data components; and
generating an error message to be presented on a web page.

12. The system of claim 10, wherein the set of installment options includes an option for a user to submit a portion of the requested resources to the resource server before receiving the requested resources.

13. The system of claim 10, wherein the set of installment options includes an option to immediately acquire the requested resources.

14. The system of claim 10, wherein the set of installment options includes a denial of providing the requested resources but instead an approval associated with a portion of the requested resources.

15. The system of claim 10, wherein transmitting the API request includes:
generating a digital signature for the API request;
encrypting the API request to generate an encrypted request; and
transmitting the digital signature and the encrypted request.

16. The system of claim 10, wherein the response message is generated based on a score generated by a data-aggregation server.

17. The system of claim 10, wherein the instructions further cause the system to perform operations comprising:
accessing terms-and-conditions data associated with the selected installment option before transmitting the selected installment option; and
transmitting the terms-and-conditions data, wherein when a user device receives the terms-and-conditions data, the user device transmits an acceptance of the terms-and-conditions data.

18. The system of claim 10, wherein the instructions further cause the system to perform operations comprising:
receiving a request to terminate the transaction; and
transmitting the one or more resources associated with the selected installment option when the request to terminate the transaction is received.

19. A non-transitory, computer-readable storage medium storing thereon executable instructions that, as a result of being executed by one or more processors of a computer system, cause the computer system to perform operations comprising:
receiving user-profile data associated with a request for resources to fulfill a transaction;
constructing an application-programming interface (API) request based on the user-profile data;
transmitting the API request, wherein when the API request is received at a resource server, the resource server dynamically generates and transmits a response message;
parsing the response message to identify a set of installment options;
associating the set of installment options with a set of graphical user-interface elements;
receiving a selection of an installment option, wherein the selection of the installment option is associated with a user interaction with a graphical user-interface element;
transmitting the selected installment option, wherein when the selected installment option is received at the resource server, the resource server authorizes transmittal of one or more resources associated with the selected installment option;
fulfilling the transaction after transmitting the selected installment option; and
receiving the one or more resources associated with the selected installment option after fulfillment of the transaction.

20. The non-transitory, computer-readable storage medium of claim 19, wherein constructing the API request includes:
parsing the user-profile data to determine that the user-profile data include one or more erroneous data components; and
generating an error message to be presented on a web page.

21. The non-transitory, computer-readable storage medium of claim 19, wherein the set of installment options includes an option for a user to submit a portion of the requested resources to the resource server before receiving the requested resources.

22. The non-transitory, computer-readable storage medium of claim 19, wherein the set of installment options includes an option to immediately acquire the requested resources.

23. The non-transitory, computer-readable storage medium of claim 19, wherein the set of installment options includes a denial of providing the requested resources but instead an approval associated with a portion of the requested resources.

24. The non-transitory, computer-readable storage medium of claim 19, wherein transmitting the API request includes:
generating a digital signature for the API request;
encrypting the API request to generate an encrypted request; and
transmitting the digital signature and the encrypted request.

25. The non-transitory, computer-readable storage medium of claim 19, wherein the response message is generated based on a score generated by a data-aggregation server.

26. The non-transitory, computer-readable storage medium of claim 19, wherein the instructions further cause the system to perform operations comprising:
accessing terms-and-conditions data associated with the selected installment option before transmitting the selected installment option; and
transmitting the terms-and-conditions data, wherein when a user device receives the terms-and-conditions data, the user device transmits an acceptance of the terms-and-conditions data.

27. The non-transitory, computer-readable storage medium of claim 19, wherein the instructions further cause the system to perform operations comprising:
receiving a request to terminate the transaction; and
transmitting the one or more resources associated with the selected installment option when the request to terminate the transaction is received.
